(19) United States
(12) Patent Application Publication
(10) Pub. No.: US 2024/0210658 A1
(43) Pub. Date: Jun. 27, 2024

(54) OPTICAL IMAGING SYSTEM

(71) Applicant: SAMSUNG ELECTRO-MECHANICS CO., LTD., Suwon-si (KR)

(72) Inventors: Dong Hyuk JANG, Suwon-si (KR); Sang Hyun JANG, Suwon-si (KR)

(73) Assignee: SAMSUNG ELECTRO-MECHANICS CO., LTD., Suwon-si (KR)

(21) Appl. No.: 18/506,504

(22) Filed: Nov. 10, 2023

(30) Foreign Application Priority Data
Dec. 23, 2022 (KR) 10-2022-0183472

(51) Int. Cl. G02B 13/00; G02B 9/64

(52) U.S. Cl. CPC G02B 13/0045; G02B 9/64

(57) ABSTRACT

An optical imaging system is provided. The optical imaging system includes a first lens, a second lens, a third lens, a fourth lens, a fifth lens, a sixth lens, a seventh lens, an eighth lens, a ninth lens, and a tenth lens sequentially disposed from an object side to an imaging side. In the optical imaging system, a lens has positive refractive power. For example, in the optical imaging system, the third lens has positive refractive power. The optical imaging system satisfies the following conditional expressions: TTL/(2*ImgHT)<0.66 and 0.5 mm<SmT3456<1.5 mm. In the conditional expressions, TTL is a distance from an object-side surface of the first lens to an image plane, ImgHT is a height of the image plane, and SmT3456 is a sum of thicknesses of the third lens to the sixth lens.

### CROSS-REFERENCE TO RELATED APPLICATIONS

This application claims the benefit under 35 USC § 119(a) of Korean Patent Application No. 10-2022-0183472 filed on Dec. 23, 2022, in the Korean Intellectual Property Office, the entire disclosure of which is incorporated herein by reference for all purposes.

### BACKGROUND

### 1. Field

The following description relates to an optical imaging system.

### 2. Description of Related Art

Portable electronic devices may include a camera module that captures images or records videos. For example, a camera module may be mounted on devices, such as, but not limited to, a mobile phone, a laptop computer, or a game machine.

The resolution of the camera module may be affected by the optical properties of an optical imaging system and the illuminance of an imaging location. For example, high-resolution imaging may be possible in a brightly illuminated location or area. However, high-resolution imaging may be difficult in a darkly illuminated locations or areas. Therefore, it may be beneficial to implement an optical imaging system which has a low f number to enable high-resolution imaging even in a dark location or area.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, an optical imaging system includes a first lens, a second lens, a third lens, a fourth lens, a fifth lens, a sixth lens, a seventh lens, an eighth lens, a ninth lens, and a tenth lens, wherein the third lens has positive refractive power, wherein the first lens to the tenth lens are sequentially disposed from an object side to an imaging side, and wherein TTL/(2*ImgHT)<0.66 and 0.5 mm<SmT3456<1.5 mm, where TTL is a distance from an object-side surface of the first lens to an image plane, ImgHT is a height of the image plane, and SmT3456 is a sum of thicknesses of the third lens to the sixth lens.

The optical imaging system may satisfy the conditional expression 0<f1/f<1.40, where f is a focal length of the optical imaging system and f1 is a focal length of the first lens.

The optical imaging system may satisfy the conditional expression −10<f2/f<−1.0, where f is a focal length of the optical imaging system and f2 is a focal length of the second lens.

The optical imaging system may satisfy the conditional expression 1.0<|f3/f|<35, where f is a focal length of the optical imaging system and f3 is a focal length of the third lens.

The optical imaging system may satisfy the conditional expression 3.0<|f5/f|<20, where f is a focal length of the optical imaging system and f5 is a focal length of the fifth lens.

The optical imaging system may satisfy the conditional expression −10<f6/f<−1.0, where f is a focal length of the optical imaging system and f6 is a focal length of the sixth lens.

The optical imaging system may satisfy the conditional expression 2.0<f7/f<15, where f is a focal length of the optical imaging system and f7 is a focal length of the seventh lens.

The optical imaging system may satisfy the conditional expression 0<f9/f<2.0, where f is a focal length of the optical imaging system and f9 is a focal length of the ninth lens.

The optical imaging system may satisfy the conditional expression −1.0<f10/f<0, where f is a focal length of the optical imaging system and f10 is a focal length of the tenth lens.

An electronic device may include the optical imaging system.

In a general aspect, an optical imaging system includes a first lens, a second lens, a third lens, a fourth lens, a fifth lens, a sixth lens, a seventh lens, an eighth lens, a ninth lens, and a tenth lens, wherein the third lens has positive refractive power, wherein the first lens to the tenth lens are sequentially disposed from an object side to an imaging side, and wherein 0.9<f2/f6<1.20, where f2 is a focal length of the second lens and f6 is a focal length of the sixth lens.

The optical imaging system may satisfy the conditional expression 0.6<f1/f9<1.0, where f1 is a focal length of the first lens and f9 is a focal length of the ninth lens.

The optical imaging system may satisfy the conditional expression 0.9<f5/f7<1.50, where f5 is a focal length of the fifth lens and f7 is a focal length of the seventh lens.

The optical imaging system may satisfy the conditional expression −2.0<f9/f10<−1.2, where f9 is a focal length of the ninth lens and f10 is a focal length of the tenth lens.

The optical imaging system may satisfy the conditional expression −3.0<(f1+f7)/(f2+f6)<−0.8, where f1 is a focal length of the first lens and f7 is a focal length of the seventh lens.

The optical imaging system may satisfy the conditional expression 1.6<f3/R5−f3/R6<2.0, where f3 is a focal length of the third lens, R5 is a radius of curvature of an object-side surface of the third lens, and R6 is a radius of curvature of an image-side surface of the third lens.

The optical imaging system may satisfy the conditional expression 0.5<|R20/f10|<0.6, where f10 is a focal length of the tenth lens and R20 is a radius of curvature of an image-side surface of the tenth lens.

An electronic device may include the optical imaging system.
in a general aspect, an optical imaging system includes a first lens, a second lens, a third lens, a fourth lens, a fifth lens, a sixth lens, a seventh lens, an eighth lens, a ninth lens, and a tenth lens, wherein the fourth lens has negative refractive power, wherein the eighth lens has positive refractive power, wherein the first lens to the tenth lens are sequentially disposed from an object side to an imaging side, and wherein TTL/(2*ImgHT)<0.66, where TTL is a distance from an object-side surface of the first lens to an image plane, and ImgHT is a height of the image plane.

Other features and examples will be apparent from the following detailed description, the drawings, and the claims.

### BRIEF DESCRIPTION OF DRAWINGS

FIG. 1 is a configuration diagram illustrating an example optical imaging system according to a first example embodiment.

FIG. 2 is an aberration curve of the example optical imaging system illustrated in FIG. 1.

FIG. 3 is a configuration diagram illustrating an example optical imaging system according to a second example embodiment.

FIG. 4 is an aberration curve of the example optical imaging system illustrated in FIG. 3.

FIG. 5 is a configuration diagram illustrating an example optical imaging system according to a third example embodiment.

FIG. 6 is an aberration curve of the example optical imaging system illustrated in FIG. 5.

FIG. 7 is a configuration diagram illustrating an example optical imaging system according to a fourth example embodiment.

FIG. 8 is an aberration curve of the example optical imaging system illustrated in FIG. 7.

FIG. 9 is a configuration diagram illustrating an example optical imaging system according to a fifth example embodiment.

FIG. 10 is an aberration curve of the example optical imaging system illustrated in FIG. 9.

FIG. 11 is a configuration diagram illustrating an example optical imaging system according to a sixth example embodiment.

FIG. 12 is an aberration curve of the example optical imaging system illustrated in FIG. 11.

FIG. 13 is a configuration diagram illustrating an example optical imaging system according to a seventh example embodiment.

FIG. 14 is an aberration curve of the example optical imaging system illustrated in FIG. 13.

FIG. 15 is a configuration diagram illustrating an example optical imaging system according to an eighth example embodiment.

FIG. 16 is an aberration curve of the example optical imaging system illustrated in FIG. 15.

FIG. 17 illustrates a perspective view of an example electronic device including an example optical imaging system, in accordance with one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning, e.g., the phrasing “in one example” has a same meaning as “in one embodiment”, and “one or more examples” has a same meaning as “in one or more embodiments.”

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The one or more examples may implement a high-quality image even in a low-light environment.

One or more examples may provide an optical imaging system that implements high-resolution imaging even in a low light environment.

One or more examples may provide high-resolution imaging and image capturing even in a low-light environment.

One or more examples may provide an optical imaging system which has a wide angle of view while having a low f number.

In the one or more examples, a first lens refers to a lens closest to an object (or a subject), and a tenth lens refers to a lens closest to an image plane (or an image sensor). In the one or more examples, units of a radius of curvature, a thickness, a total track length (TTL) (a distance from an object-side surface of the first lens to an image plane), image height (ImgHT) (a height of an image plane), and a focal length of a lens may be indicated in “mm.”

A thickness of a lens, a distance between lenses, and TTL may be sizes calculated based on an optical axis of an optical imaging system. Additionally, in the description of a shape of a lens in the one or more examples, one surface that is convex means that a paraxial region of the surface is convex, and one surface that is concave means that a paraxial region of the surface is concave. Therefore, even when it is described that one surface of the lens is convex, an edge portion of the lens may be concave. Similarly, even when it is described that one surface of the lens is concave, an edge portion of the lens may be convex.

The optical imaging system described herein may be mounted on a portable electronic device. For example, the optical imaging system may be mounted on, as only examples, a smartphone, a laptop computer, an augmented reality device, a virtual reality device (VR), a portable game machine, and the like. However, a usage range and usage examples of the optical imaging system described herein are not limited to the above-described electronic device. For example, the optical imaging system may be applied to an electronic device providing a narrow mounting space, but desiring high-resolution imaging.

An optical imaging system according to a first example of the one or more examples may include a plurality of lenses. For example, the optical imaging system according to the first example may include a first lens, a second lens, a third lens, a fourth lens, a fifth lens, a sixth lens, a seventh lens, an eighth lens, a ninth lens, and a tenth lens sequentially disposed from an object side to an imaging side. The optical imaging system according to the first example may include a lens having positive refractive power. For example, in the optical imaging system according to the first example, the third lens may have positive refractive power. The optical imaging system according to the first example may satisfy a specific conditional expression. For example, the optical imaging system according to the first example may satisfy the following conditional expressions: TTL/(2*ImgHT)<0.66 and 0.5 mm<SmT3456<1.5 mm. In the conditional expressions, TTL may be a distance from an object-side surface of the first lens to an image plane, ImgHT may be a height of the image plane, and SmT3456 may be a sum of thicknesses of the third to sixth lenses.

An optical imaging system according to a second example of the one or more examples may include a plurality of lenses. For example, the optical imaging system according to the second example may include a first lens, a second lens, a third lens, a fourth lens, a fifth lens, a sixth lens, a seventh lens, and an eighth lens, a ninth lens, and a tenth lens sequentially disposed from an object side to an imaging side. The optical imaging system according to the second example may include a lens having positive refractive power. For example, in the optical imaging system according to the second example, the third lens may have positive refractive power. The optical imaging system according to the second example may satisfy a specific conditional expression. For example, the optical imaging system according to the second example may satisfy the following conditional expression: 0.9<f2/f6<1.20. In the conditional expression, f2 may be a focal length of the second lens, and f6 may be a focal length of the sixth lens.

An optical imaging system according to a third example of the one or more examples may include a first lens, a second lens, a third lens, a fourth lens, a fifth lens, a sixth lens, a seventh lens, an eighth lens, a ninth lens, and a tenth lens sequentially disposed from an object side to an imaging side, and may satisfy one or more of the following conditional expressions.

$$0 < f 1 / f < 1.40$$

$$25 < V 1 - V 2 < 45$$

$$15 < V 3 - V 2 < 45$$

$$10 < V 1 ( V 6 + V 6 ) / 2 < 30$$

$$- 10 < f 2 / f < - 1.0$$

$$1. < \vert f 3 / f \vert < 35$$

$$3. < \vert f 5 / f \vert < 20$$

$$- 10 < f 6 / f < - 1.0$$

$$2. < f 7 / f < 15$$

$$0 < f 9 / f < 2.0$$

$$- 1. < f 10 / f < 0$$

$$TTL / f < 1.30$$

$$- 1. < f 1 / f 2 < 0$$

$$0.01 < f 1 / f 3 < 1.0$$

$$0 < BFL / f < 0.3$$

$$0 < D 12 / f < 0.3$$

$$TTL / ( 2 * ImgHT ) < 0.66$$

$$70 ° < FOV * ImgHT / f$$

$$0.3 mm < SmT 23 < 0.8 mm$$

$$0.5 mm < SmT 3456 < 1.5 mm$$

$$0 < SmT 23 / TTL < 1.2$$

$$0.9 < f 2 / f 6 < 1.20$$

In the conditional expressions above, f may be a focal length of the optical imaging system, f1 may be a focal length of the first lens, f2 may be a focal length of the second lens, f3 may be a focal length of the third lens, f5 may be a focal length of the fifth lens, f6 may be a focal length of the sixth lens, f7 may be a focal length of the seventh lens, f9 may be a focal length of the ninth lens, f10 may be a focal length of the tenth lens, V1 may be an Abbe number of the first lens, V2 may be an Abbe number of the second lens, V3 may be an Abbe number of the third lens, V6 may be an Abbe number of the sixth lens, V7 may be an Abbe number of the seventh lens, TTL may be a distance from an object-side surface of the first lens to an image plane, BFL may be a distance from an image-side surface of the tenth lens to the image plane, D12 may be a distance from an image-side surface of the first lens to an object-side surface of the second lens, ImgHT may be a height of the image plane, FOV may be an angle of view of the optical imaging system, SmT23 may be a sum of thicknesses of the second and third lenses, and SmT3456 may be a sum of thicknesses of the third to sixth lenses.

An optical imaging system according to a fourth example may include a first lens, a second lens, a third lens, a fourth lens, a fifth lens, a sixth lens, a seventh lens, an eighth lens, a ninth lens, and a tenth lens sequentially disposed from an object side to an imaging side, and may satisfy one or more of the following conditional expressions.

$$0.6 < f 1 / f 9 < 1.0$$

$$0.9 < f 5 / f 7 < 1.50$$

$$- 2. < f 9 / f 10 < - 1.20$$

$$- 3. < ( f 1 + f 7 ) / ( f 2 + f 6 ) < - 0.8$$

$$1. < R 17 / R 20 < 1.50$$

$$0.5 < \vert R 20 / f 10 \vert < 0.6$$

$$3. < f 3 / R 5 < 8.0$$

$$2. < f 3 / R 6 < 5.0$$

$$1.5 < f 3 / R 5 - f 3 / R 6 < 2.0$$

$$1.8 < f 4 / R 7 - f 4 / R 8 < 1.9$$

$$1.2 < f 6 / R 11 < 1.40$$

$$- 0.3 \; 0 < f 6 / R 12 < - 0.10$$

$$1.4 < f 6 / R 11 - f 6 / R 12 < 1.6$$

In the conditional expressions above, f4 may be a focal length of the fourth lens, R5 may be a radius of curvature of an object-side surface of the third lens, R6 may be a radius of curvature of an image-side surface of the third lens, R7 may be a radius of curvature of an object-side surface of the fourth lens, R8 may be a radius of curvature of an image-side surface of the fourth lens, R11 may be a radius of curvature of an object-side surface of the sixth lens, R12 may be a radius of curvature of an image-side surface of the sixth lens, R17 may be a radius of curvature of an object-side surface of the ninth lens, and R20 may be a radius of curvature of an image-side surface of the tenth lens.

An optical imaging system according to a fifth example may include one or more of features (conditional expressions) according to the third example and features (conditional expressions) according to the fourth example, while including features according to the first example.

An optical imaging system according to a sixth example may include one or more of features (conditional expressions) according to the third example and features (conditional expressions) according to the fourth example, while including features according to the second example.

An optical imaging system according to a seventh example may include a first lens, a second lens, a third lens, a fourth lens, a fifth lens, a sixth lens, a seventh lens, an eighth lens, a ninth lens, and a tenth lens sequentially disposed from an object side to an imaging side, and may simultaneously satisfy one or more of conditional expressions according to the third example and one or more of conditional expressions according to the fourth example.

The optical imaging systems according to the first example to the seventh example may include one or more lenses having the following features, as necessary. As an example, the optical imaging system according to the first example may include one of the first to tenth lenses according to the following features. As another example, the optical imaging system according to the second example may include two or more of the first to tenth lenses according to the following features. However, the optical imaging systems according to the above-described examples may not necessarily include a lens according to the following features.

Hereinafter, features of the first to tenth lenses will be described.

The first lens may have refractive power. For example, the first lens may have positive refractive power. One surface of the first lens may be convex. For example, an object-side surface of the first lens may be convex. The first lens may have a spherical surface or an aspherical surface. As an example, both surfaces of the first lens may be aspherical surfaces. The first lens may be formed of a material having high light transmittance and excellent processability. For example, the first lens may be formed of a plastic material or a glass material. The first lens may have a predetermined refractive index. As an example, the refractive index of the first lens may be less than 1.6. As a specific example, the refractive index of the first lens may be greater than 1.52 and less than 1.57. The first lens may have a predetermined Abbe number. As an example, the Abbe number of the first lens may be less than 60. As a specific example, the Abbe number of the first lens may be greater than 53 and less than 58.

The second lens may have refractive power. For example, the second lens may have negative refractive power. One surface of the second lens may be convex. For example, an object-side surface of the second lens may be convex. The second lens may have a spherical surface or an aspherical surface. As an example, both surfaces of the second lens may be aspherical surfaces. The second lens may be formed of a material having high light transmittance and excellent processability. For example, the second lens may be formed of a plastic material or a glass material. The second lens may have a predetermined refractive index. As an example, the refractive index of the second lens may be greater than 1.6. As a specific example, the refractive index of the second lens may be greater than 1.65 and less than 1.70. The second lens may have a predetermined Abbe number. As an example, the Abbe number of the second lens may be less than 30. As a specific example, the Abbe number of the second lens may be greater than 16 and less than 24.

The third lens may have refractive power. For example, the third lens may have positive or negative refractive power. One surface of the third lens may be convex. For example, an object-side surface of the third lens may be convex. The third lens may have a spherical surface or an aspherical surface. As an example, both surfaces of the third lens may be aspherical surfaces. The third lens may be formed of a material having high light transmittance and excellent processability. For example, the third lens may be formed of a plastic material or a glass material. The third lens may have a predetermined refractive index. As an example, the refractive index of the third lens may be less than 1.6. As a specific example, the refractive index of the third lens may be greater than 1.52 and less than 1.58. The third lens may have a predetermined Abbe number. As an example, the Abbe number of the third lens may be less than 60.

The fourth lens may have refractive power. For example, the fourth lens may have positive or negative refractive power. One side surface of the fourth lens may be convex. For example, an object-side surface of the fourth lens may be convex. The fourth lens may have a spherical surface or an aspherical surface. As an example, both surfaces of the fourth lens may be aspherical surfaces. The fourth lens may be formed of a material having high light transmittance and excellent processability. For example, the fourth lens may be formed of a plastic material or a glass material. The fourth lens may have a predetermined refractive index. As an example, the refractive index of the fourth lens may be less than 1.6. As a specific example, the refractive index of the fourth lens may be greater than 1.5 and less than 1.6. The fourth lens may have a predetermined Abbe number. As an example, the Abbe number of the fourth lens may be 50 or more. As a specific example, the Abbe number of the fourth lens may be greater than 50 and less than 60.

The fifth lens may have refractive power. For example, the fifth lens may have positive refractive power. One surface of the fifth lens may be concave. As an example, an object-side surface of the fifth lens may be concave. The fifth lens may have a spherical surface or an aspherical surface. As an example, both surfaces of the fifth lens may be aspherical surfaces. The fifth lens may be formed of a material having high light transmittance and excellent processability. For example, the fifth lens may be formed of a plastic material or a glass material. The fifth lens may have a predetermined refractive index. As an example, the refractive index of the fifth lens may be greater than 1.6. As a specific example, the refractive index of the fifth lens may be greater than 1.65 and less than 1.70. The fifth lens may have a predetermined Abbe number. As an example, the Abbe number of the fifth lens may be less than 30. As a specific example, the Abbe number of the fifth lens may be greater than 16 and less than 24.

The sixth lens may have refractive power. For example, the sixth lens may have negative refractive power. One surface of the sixth lens may be concave. For example, an object-side surface of the sixth lens may be concave. The sixth lens may have a spherical surface or an aspherical surface. As an example, both surfaces of the sixth lens may be aspherical surfaces. The sixth lens may be formed of a material having high light transmittance and excellent processability. For example, the sixth lens may be formed of a plastic material or a glass material. The sixth lens may have a predetermined refractive index. As an example, the refractive index of the sixth lens may be greater than 1.6. As a specific example, the refractive index of the sixth lens may be greater than 1.65 and less than 1.70. The sixth lens may have a predetermined Abbe number. As an example, the Abbe number of the sixth lens may be less than 30. As a specific example, the Abbe number of the sixth lens may be greater than 16 and less than 28.

The seventh lens may have refractive power. For example, the seventh lens may have positive refractive power. One surface of the seventh lens may be convex. For example, an object-side surface of the seventh lens may be convex. The seventh lens may have a spherical surface or an aspherical surface. As an example, both surfaces of the seventh lens may be aspherical surfaces. One surface or both surfaces of the seventh lens may have an inflection point. For example, the object-side surface and image-side surface of the seventh lens may have an inflection point. The seventh lens may be formed of a material having high light transmittance and excellent processability. For example, the seventh lens may be formed of a plastic material or a glass material. The seventh lens may have a predetermined refractive index. As an example, the refractive index of the seventh lens may be greater than 1.52. As a specific example, the refractive index of the seventh lens may be greater than 1.52 and less than 1.64. The seventh lens may have a predetermined Abbe number. As an example, the Abbe number of the seventh lens may be less than 60. As a specific example, the Abbe number of the seventh lens may be greater than 50 and less than 60.

The eighth lens may have refractive power. For example, the eighth lens may have positive or negative refractive power. One surface of the eighth lens may be convex. For example, an object-side surface of the eighth lens may be convex. The eighth lens may have a spherical surface or an aspherical surface. As an example, both surfaces of the eighth lens may be aspherical surfaces. One surface or both surfaces of the eighth lens may have an inflection point. For example, the object-side surface and image-side surface of the eighth lens may have an inflection point. The eighth lens may be formed of a material having high light transmittance and excellent processability. For example, the eighth lens may be formed of a plastic material or a glass material. The eighth lens may have a predetermined refractive index. As an example, the refractive index of the eighth lens may be less than 1.6. As a specific example, the refractive index of the eighth lens may be greater than 1.54 and less than 1.60. The eighth lens may have a predetermined Abbe number. As an example, the Abbe number of the eighth lens may be less than 40. As a specific example, the Abbe number of the eighth lens may be greater than 20 and less than 40.

The ninth lens may have refractive power. For example, the ninth lens may have positive refractive power. One surface of the ninth lens may be convex. For example, an object-side surface of the ninth lens may be convex. The ninth lens may have a spherical surface or an aspherical surface. As an example, both surfaces of the ninth lens may be aspherical surfaces. In an example, one surface or both surfaces of the ninth lens may have an inflection point. For example, the object-side surface and image-side surface of the ninth lens may have an inflection point. The ninth lens may be formed of a material having high light transmittance and excellent processability. For example, the ninth lens may be formed of a plastic material or a glass material. The ninth lens may have a predetermined refractive index. As an example, the refractive index of the ninth lens may be greater than 1.52. As a specific example, the refractive index of the ninth lens may be greater than 1.50 and less than 1.60. The ninth lens may have a predetermined Abbe number. As an example, the Abbe number of the ninth lens may be less than 60. As a specific example, the Abbe number of the ninth lens may be greater than 50 and less than 60.

The tenth lens may have refractive power. For example, the tenth lens may have negative refractive power. One surface of the tenth lens may be concave. For example, an object-side surface of the tenth lens may be concave. The tenth lens may have a spherical surface or an aspherical surface. As an example, both surfaces of the tenth lens may be aspherical surfaces. One surface or both surfaces of the tenth lens may have an inflection point. For example, the object-side surface and image-side surface of the tenth lens may have an inflection point. The tenth lens may be formed of a material having high light transmittance and excellent processability. For example, the tenth lens may be formed of a plastic material or a glass material. The tenth lens may have a predetermined refractive index. As an example, the refractive index of the tenth lens may be greater than 1.52. As a specific example, the refractive index of the tenth lens may be greater than 1.50 and less than 1.60. The tenth lens may have a predetermined Abbe number. As an example, the Abbe number of the tenth lens may be less than 60. As a specific example, the Abbe number of the tenth lens may be greater than 50 and less than 60.

As described above, the first to tenth lenses may have a spherical surface or an aspherical surface. When the first to tenth lenses has an aspherical surface, an aspherical surface of a corresponding lens may be represented by Equation 1 below.

$$Z = \frac{{cr}^{2}}{1 + \sqrt{1 - ( 1 + k ) {c}^{2} {r}^{2}}} + {Ar}^{4} + {Br}^{6} + {Cr}^{8} + {Dr}^{10} + {Er}^{12} + {Fr}^{14} + {Gr}^{16} + {Hr}^{18} + {Jr}^{20} \qquad Equation 1$$

In Equation 1, c may be a reciprocal of a radius of curvature of a corresponding lens, k may be a conic constant, r may be a distance from an arbitrary point on an aspherical surface to an optical axis, A to H and J may be aspherical constants, and Z (or SAG) may be a height in an optical axis direction from an arbitrary point on an aspherical surface to an apex of the aspherical surface.

The optical imaging systems according to the above-described example embodiments or the above-described examples may further include an aperture and a filter. As an example, the optical imaging systems may further include an aperture disposed on an object side of a first lens or disposed between lenses. As another example, the example optical imaging systems may further include a filter disposed between a tenth lens and an image plane. The aperture may be configured to adjust an amount of light incident in a direction of the image plane, and the filter may be configured to block light having a specific wavelength. For reference, the filter described herein may be configured to block an infrared ray, but light having a wavelength blocked by the filter is not limited to the infrared ray.

Specific example embodiments of the example optical imaging system will be described with reference to the drawings.

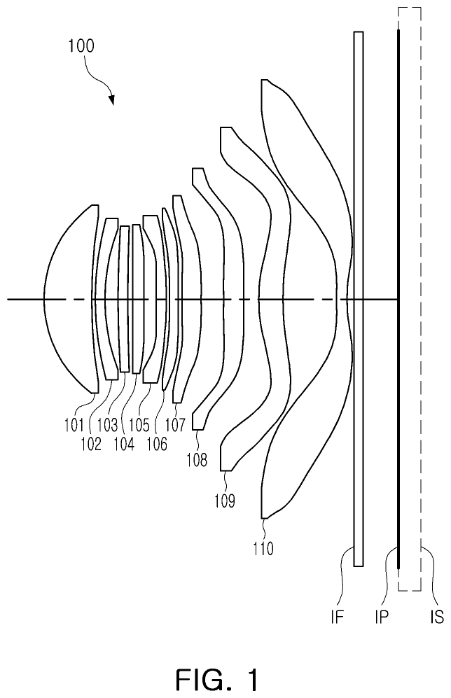

First, an optical imaging system according to a first example embodiment will be described with reference to FIG. 1.

An example optical imaging system 100 may include a first lens 101, a second lens 102, a third lens 103, a fourth lens 104, a fifth lens 105, a sixth lens 106, a seventh lens 107, an eighth lens 108, a ninth lens 109, and a tenth lens 110.

The first lens 101 may have positive refractive power, and may have a convex object-side surface and a concave image-side surface. The second lens 102 may have negative refractive power, and may have a convex object-side surface and a concave image-side surface. The third lens 103 may have positive refractive power, and may have a convex object-side surface and a concave image-side surface. The fourth lens 104 may have negative refractive power, and may have a convex object-side surface and a concave image-side surface. The fifth lens 105 may have positive refractive power, and may have a concave object-side surface and a convex image-side surface. The sixth lens 106 may have negative refractive power, and may have a concave object-side surface and a concave image-side surface. The seventh lens 107 may have positive refractive power, and may have a convex object-side surface and a convex image-side surface. In addition, the object-side surface and image-side surface of the seventh lens 107 may have an inflection point. The eighth lens 108 may have positive refractive power, and may have a convex object-side surface and a concave image-side surface. Additionally, the object-side surface and image-side surface of the eighth lens 108 may have an inflection point. The ninth lens 109 may have positive refractive power, and may have a convex object-side surface and a concave image-side surface. Additionally, the object-side surface and image-side surface of the ninth lens 109 may have an inflection point. The tenth lens 110 may have negative refractive power, and may have a concave object-side surface and a concave image-side surface. Additionally, the object-side surface and image-side surface of the tenth lens 110 may have an inflection point.

The example optical imaging system 100 may further include a filter IF and an image plane IP. The filter IF may be disposed between the tenth lens 110 and the image plane IP. In an example, the filter IF may be omitted, as necessary. The image plane IP may be formed on one surface or an inside of an image sensor IS of a camera module. However, a position of the image plane IP is not limited to the one surface or the inside of the image sensor IS.

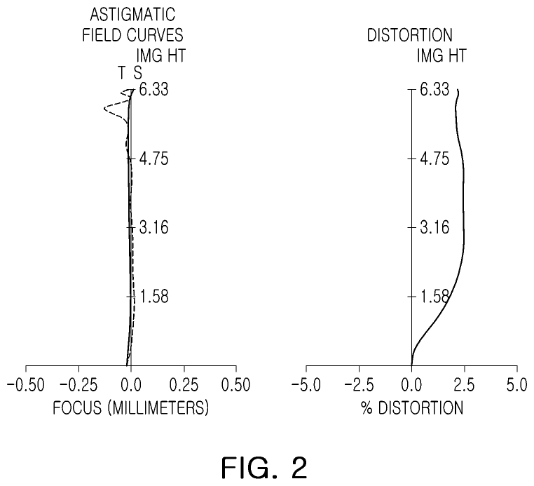

Tables 1 and 2 below illustrate lens properties and aspherical surface values of the example optical imaging system according to the present example embodiment. FIG. 2 is an aberration curve of the optical imaging system according to the present example embodiment.

TABLE 1

| Surface | | Radius of | Thickness/ | Refractive | Abbe |
|---|---|---|---|---|---|
| No. | Component | Curvature | Distance | Index | Number |
| S1 | First lens | 2.7510 | 1.0814 | 1.544 | 56.0 |
| S2 | | 13.5604 | 0.0725 | | |
| S3 | Second lens | 7.1580 | 0.2000 | 1.671 | 19.4 |
| S4 | | 4.0766 | 0.3265 | | |
| S5 | Third lens | 12.6750 | 0.2133 | 1.544 | 56.0 |
| S6 | | 23.3986 | 0.0903 | | |
| S7 | Fourth lens | 116.7404 | 0.2717 | 1.544 | 56.0 |
| S8 | | 79.6433 | 0.2833 | | |
| S9 | Fifth lens | −29.3848 | 0.2133 | 1.671 | 19.4 |
| S10 | | −12.7344 | 0.0842 | | |
| S11 | Sixth lens | −10.5624 | 0.2006 | 1.651 | 21.5 |
| S12 | | 84.8079 | 0.0862 | | |
| S13 | Seventh lens | 58.3411 | 0.4245 | 1.544 | 56.0 |
| S14 | | −26.2540 | 0.4977 | | |
| S15 | Eighth lens | 16.5375 | 0.4608 | 1.567 | 37.4 |
| S16 | | 16.4894 | 0.3336 | | |
| S17 | Ninth lens | 3.1353 | 0.5554 | 1.544 | 56.0 |
| S18 | | 14.4713 | 1.2179 | | |
| S19 | Tenth lens | −635.9441 | 0.2216 | 1.535 | 55.7 |
| S20 | | 2.6609 | 0.1652 | | |
| S21 | Filter | Infinity | 0.2100 | 1.517 | 64.2 |
| S22 | | Infinity | 0.7700 | | |
| S23 | Image plane | Infinity | 0.0200 | | |

TABLE 2

| | Surface No. | | | | | | |
|---|---|---|---|---|---|---|---|
| | S1 | S2 | S3 | S4 | S5 | S6 | S7 |
| K | −3.32E−01 | 1.81E+01 | −1.49E+01 | −4.78E+00 | −2.61E+00 | −2.60E+01 | −9.90E+01 |
| A | 9.09E−04 | 6.73E−03 | 1.91E−04 | 3.50E−05 | −6.08E−03 | 3.29E−03 | −2.53E−04 |
| B | 1.27E−02 | −1.42E−02 | −1.54E−02 | −2.70E−02 | −3.55E−03 | −2.53E−03 | 2.17E−04 |
| C | −3.80E−02 | 2.73E−02 | 3.14E−02 | 1.29E−01 | −1.58E−03 | −1.44E−02 | 1.17E−02 |
| D | 7.49E−02 | −4.70E−02 | −4.71E−02 | −4.12E−01 | −3.69E−02 | 4.66E−02 | −1.01E−01 |
| E | −9.89E−02 | 6.36E−02 | 5.86E−02 | 9.12E−01 | 1.87E−01 | −8.42E−02 | 3.60E−01 |
| F | 9.13E−02 | −6.32E−02 | −5.47E−02 | −1.41E+00 | −4.43E−01 | 1.00E−01 | −7.55E−01 |
| G | −6.04E−02 | 4.56E−02 | 3.71E−02 | 1.55E+00 | 6.45E−01 | −7.92E−02 | 1.04E+00 |
| H | 2.90E−02 | −2.39E−02 | −1.80E−02 | −1.23E+00 | −6.26E−01 | 4.24E−02 | −9.76E−01 |
| J | −1.01E−02 | 9.10E−03 | 6.11E−03 | 7.02E−01 | 4.18E−01 | −1.55E−02 | 6.42E−01 |
| K | 2.52E−03 | −2.48E−03 | −1.41E−03 | −2.86E−01 | −1.93E−01 | 3.90E−03 | −2.96E−01 |
| M | −4.40E−04 | 4.72E−04 | 2.05E−04 | 8.11E−02 | 6.07E−02 | −6.61E−04 | 9.34E−02 |
| N | 5.09E−05 | −5.96E−05 | −1.54E−05 | −1.52E−02 | −1.24E−02 | 7.22E−05 | −1.93E−02 |
| O | −3.51E−06 | 4.47E−06 | 1.48E−07 | 1.68E−03 | 1.48E−03 | −4.59E−06 | 2.35E−03 |
| P | 1.09E−07 | −1.51E−07 | 3.90E−08 | −8.32E−05 | −7.88E−05 | 1.29E−07 | −1.28E−04 |
| | Surface No. | | | | | | |
| | S8 | S9 | S10 | S11 | S12 | S13 | S14 |
| K | 9.90E+01 | 3.34E+01 | 2.02E+01 | 7.07E+00 | 9.90E+01 | 8.28E+01 | −9.09E+01 |
| A | −8.15E−03 | −1.67E−02 | 6.38E−03 | −6.75E−05 | −1.35E−02 | −1.47E−02 | −1.39E−02 |
| B | −3.43E−02 | 7.92E−03 | −1.17E−02 | 1.80E−02 | 5.78E−04 | −9.25E−03 | −7.27E−03 |
| C | 1.83E−01 | −9.39E−02 | −4.80E−03 | −8.65E−02 | −1.49E−03 | 4.15E−05 | −7.81E−03 |
| D | −6.21E−01 | 3.17E−01 | 6.25E−02 | 2.17E−01 | −1.84E−02 | 2.33E−02 | 2.95E−02 |
| E | 1.39E+00 | −6.56E−01 | −1.47E−01 | −3.50E−01 | 6.34E−02 | −4.65E−02 | −4.30E−02 |
| F | −2.13E+00 | 9.04E−01 | 2.00E−01 | 3.88E−01 | −1.03E−01 | 5.35E−02 | 3.88E−02 |
| G | 2.33E+00 | −8.62E−01 | −1.82E−01 | −3.08E−01 | 1.03E−01 | −4.16E−02 | −2.35E−02 |
| H | −1.83E+00 | 5.81E−01 | 1.16E−01 | 1.77E−01 | −6.87E−02 | 2.24E−02 | 9.93E−03 |
| J | 1.04E+00 | −2.77E−01 | −5.28E−02 | −7.40E−02 | 3.20E−02 | −8.35E−03 | −2.93E−03 |
| K | −4.21E−01 | 9.22E−02 | 1.70E−02 | 2.21E−02 | −1.05E−02 | 2.15E−03 | 6.02E−04 |
| M | 1.19E−01 | −2.08E−02 | −3.80E−03 | −4.62E−03 | 2.34E−03 | −3.76E−04 | −8.39E−05 |
| N | −2.22E−02 | 2.98E−03 | 5.57E−04 | 6.36E−04 | −3.42E−04 | 4.23E−05 | 7.53E−06 |
| O | 2.46E−03 | −2.38E−04 | −4.83E−05 | −5.18E−05 | 2.94E−05 | −2.77E−06 | −3.91E−07 |
| P | −1.22E−04 | 7.66E−06 | 1.87E−06 | 1.89E−06 | −1.13E−06 | 8.05E−08 | 8.87E−09 |

| | Surface No. | | | | | |
|---|---|---|---|---|---|---|
| | S15 | S16 | S17 | S18 | S19 | S20 |
| K | −9.70E−01 | −9.90E+01 | −1.31E+01 | −5.52E+00 | 9.90E+01 | −1.15E+01 |
| A | −6.34E−03 | −2.79E−02 | 5.91E−02 | 5.52E−02 | −1.10E−01 | −5.53E−02 |
| B | −2.09E−02 | −3.89E−02 | −7.03E−02 | −3.65E−02 | 3.43E−02 | 1.29E−02 |
| C | 3.67E−02 | 6.61E−02 | 5.02E−02 | 1.30E−02 | −6.69E−03 | −3.95E−04 |
| D | −4.02E−02 | −5.95E−02 | −2.82E−02 | −3.49E−03 | 5.67E−04 | −8.29E−04 |
| E | 3.05E−02 | 3.69E−02 | 1.21E−02 | 8.07E−04 | 1.20E−04 | 3.15E−04 |
| F | −1.70E−02 | −1.68E−02 | −3.89E−03 | −1.83E−04 | −5.25E−05 | −6.46E−05 |
| G | 7.10E−03 | 5.65E−03 | 9.22E−04 | 3.85E−05 | 9.81E−06 | 8.75E−06 |
| H | −2.21E−03 | −1.40E−03 | −1.60E−04 | −6.38E−06 | −1.16E−06 | −8.28E−07 |
| J | 5.09E−04 | 2.55E−04 | 1.99E−05 | 7.65E−07 | 9.50E−08 | 5.55E−08 |
| K | −8.46E−05 | −3.32E−05 | −1.77E−06 | −6.33E−08 | −5.41E−09 | −2.62E−09 |
| M | 9.86E−06 | 3.01E−06 | 1.09E−07 | 3.51E−09 | 2.12E−10 | 8.54E−11 |
| N | −7.60E−07 | −1.79E−07 | −4.36E−09 | −1.23E−10 | −5.43E−12 | −1.82E−12 |
| O | 3.47E−08 | 6.28E−09 | 1.03E−10 | 2.45E−12 | 8.23E−14 | 2.30E−14 |
| P | −7.09E−10 | −9.84E−11 | −1.09E−12 | −2.10E−14 | −5.58E−16 | −1.29E−16 |

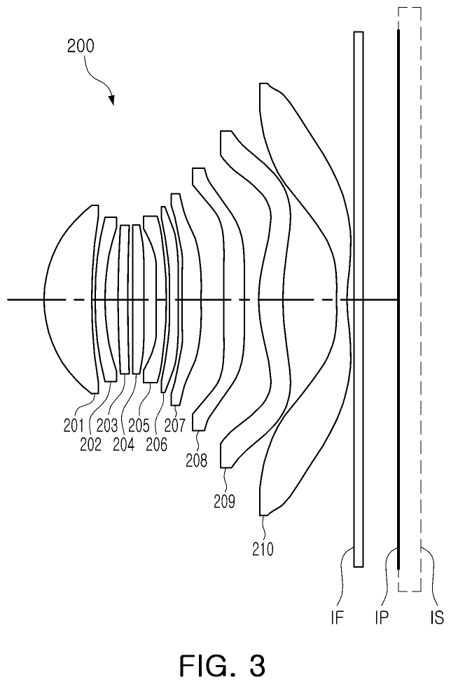

An example optical imaging system according to a second example embodiment will be described with reference to FIG. 3.

Referring to FIG. 3, an example optical imaging system 200 may include a first lens 201, a second lens 202, a third lens 203, a fourth lens 204, a fifth lens 205, a sixth lens 206, a seventh lens 207, an eighth lens 208, a ninth lens 209, and a tenth lens 210.

The first lens 201 may have positive refractive power, and may have a convex object-side surface and a concave image-side surface. The second lens 202 may have negative refractive power, and may have a convex object-side surface and a concave image-side surface.

The third lens 203 may have positive refractive power, and may have a convex object-side surface and a concave image-side surface. The fourth lens 204 may have positive refractive power, and may have a convex object-side surface and a concave image-side surface. The fifth lens 205 may have positive refractive power, and may have a concave object-side surface and a convex image-side surface. The sixth lens 206 may have negative refractive power, and may have a concave object-side surface and a concave image-side surface. The seventh lens 207 may have positive refractive power, and may have a convex object-side surface and a convex image-side surface. Additionally, the object-side surface and image-side surface of the seventh lens 207 may have an inflection point. The eighth lens 208 may have negative refractive power, and may have a convex object-side surface and a concave image-side surface. Additionally, the object-side surface and image-side surface of the eighth lens 208 may have an inflection point. The ninth lens 209 may have positive refractive power, and may have a convex object-side surface and a concave image-side surface. Additionally, the object-side surface and image-side surface of the ninth lens 209 may have an inflection point. The tenth lens 210 may have negative refractive power, and may have a concave object-side surface and a concave image-side surface. Additionally, the object-side surface and image-side surface of the tenth lens 210 may have an inflection point.

The optical imaging system 200 may further include a filter IF and an image plane IP. The filter IF may be disposed between a tenth lens 210 and the image plane IP. In an example, the filter IF may be omitted, as necessary. The image plane IP may be formed on one surface or an inside of an image sensor IS of a camera module. However, a position of the image plane IP is not limited to the one surface or the inside of the image sensor IS.

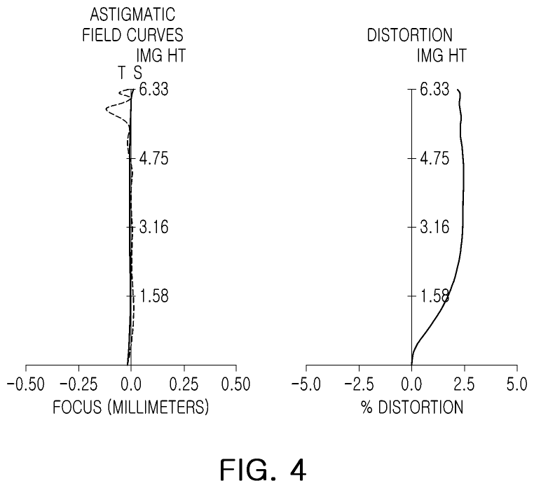

Tables 3 and 4 below illustrate lens properties and aspherical surface values of the example optical imaging system according to the present example embodiment. FIG. 4 is an aberration curve of the example optical imaging system according to the present example embodiment.

TABLE 3

| Surface | | Radius of | Thickness/ | Refractive | Abbe |
|---|---|---|---|---|---|
| No. | Component | Curvature | Distance | Index | Number |
| S1 | First lens | 2.7584 | 1.0956 | 1.544 | 56.0 |
| S2 | | 13.8108 | 0.0500 | | |
| S3 | Second lens | 6.5980 | 0.2000 | 1.671 | 19.4 |
| S4 | | 3.9640 | 0.3158 | | |
| S5 | Third lens | 11.2015 | 0.2090 | 1.567 | 37.4 |
| S6 | | 12.2015 | 0.0960 | | |
| S7 | Fourth lens | 25.0384 | 0.2776 | 1.544 | 56.0 |
| S8 | | 71.0395 | 0.3395 | | |
| S9 | Fifth lens | −21.0910 | 0.2101 | 1.671 | 19.4 |
| S10 | | −13.2213 | 0.0611 | | |
| S11 | Sixth lens | −12.2374 | 0.2000 | 1.640 | 23.5 |
| S12 | | 61.8129 | 0.0847 | | |
| S13 | Seventh | 78.6440 | 0.4123 | 1.544 | 56.0 |
| | lens | | | | |
| S14 | | −25.0553 | 0.5000 | | |
| S15 | Eighth lens | 13.9337 | 0.4867 | 1.567 | 37.4 |
| S16 | | 10.7160 | 0.3152 | | |
| S17 | Ninth lens | 2.9237 | 0.5508 | 1.544 | 56.0 |
| S18 | | 13.6987 | 1.2179 | | |
| S19 | Tenth lens | −204.0128 | 0.2216 | 1.535 | 55.7 |
| S20 | | 2.6834 | 0.1560 | | |
| S21 | Filter | Infinity | 0.2100 | 1.517 | 64.2 |
| S22 | | Infinity | 0.7740 | | |
| S23 | Image plane | Infinity | 0.0160 | | |

TABLE 4

| Surface | | | | | | | |
|---|---|---|---|---|---|---|---|
| No. | S1 | S2 | S3 | S4 | S5 | S6 | S7 |
| K | −3.47E−01 | 1.56E+01 | −1.80E+01 | −5.36E+00 | 6.92E−01 | −7.07E+01 | −9.90E+01 |
| A | 1.42E−03 | 1.37E−02 | 1.13E−02 | 5.91E−03 | −1.82E−03 | 5.29E−03 | −3.71E−03 |
| B | 1.03E−02 | −4.82E−02 | −5.95E−02 | −4.28E−02 | −2.01E−02 | −9.41E−03 | 3.96E−04 |
| C | −3.20E−02 | 9.91E−02 | 1.26E−01 | 1.43E−01 | 6.29E−02 | −4.54E−03 | 2.46E−03 |
| D | 6.53E−02 | −1.52E−01 | −2.01E−01 | −3.84E−01 | −2.29E−01 | 3.03E−02 | −4.16E−02 |
| E | −8.87E−02 | 1.77E−01 | 2.58E−01 | 7.69E−01 | 5.79E−01 | −5.38E−02 | 1.74E−01 |
| F | 8.37E−02 | −1.55E−01 | −2.55E−01 | −1.11E+00 | −9.85E−01 | 5.98E−02 | −3.73E−01 |
| G | −5.62E−02 | 1.01E−01 | 1.89E−01 | 1.15E+00 | 1.16E+00 | −4.47E−02 | 5.02E−01 |
| H | 2.73E−02 | −4.90E−02 | −1.05E−01 | −8.65E−01 | −9.64E−01 | 2.27E−02 | −4.53E−01 |
| J | −9.55E−03 | 1.74E−02 | 4.25E−02 | 4.70E−01 | 5.69E−01 | −7.92E−03 | 2.83E−01 |
| K | 2.39E−03 | −4.45E−03 | −1.25E−02 | −1.83E−01 | −2.37E−01 | 1.88E−03 | −1.23E−01 |
| M | −4.19E−04 | 8.01E−04 | 2.60E−03 | 4.95E−02 | 6.82E−02 | −2.99E−04 | 3.63E−02 |
| N | 4.85E−05 | −9.59E−05 | −3.59E−04 | −8.86E−03 | −1.29E−02 | 3.06E−05 | −6.99E−03 |
| O | −3.34E−06 | 6.86E−06 | 2.97E−05 | 9.38E−04 | 1.43E−03 | −1.81E−06 | 7.89E−04 |
| P | 1.03E−07 | −2.21E−07 | −1.11E−06 | −4.46E−05 | −7.10E−05 | 4.72E−08 | −3.97E−05 |
| Surface | | | | | | | |
| No. | S8 | S9 | S10 | S11 | S12 | S13 | S14 |
| K | 9.90E+01 | 6.16E+01 | 3.36E+01 | 1.17E+01 | −6.52E+01 | 6.86E+01 | −5.11E+01 |
| A | −7.13E−03 | −1.42E−02 | 8.81E−03 | −1.03E−04 | −9.66E−03 | −2.73E−03 | −8.85E−03 |
| B | −2.53E−02 | −4.22E−03 | −1.45E−02 | 1.73E−02 | −5.78E−03 | −2.21E−02 | −1.47E−02 |
| C | 1.26E−01 | −4.82E−02 | −7.12E−03 | −7.77E−02 | −1.28E−02 | −1.06E−02 | 1.27E−03 |
| D | −3.88E−01 | 1.90E−01 | 7.07E−02 | 1.86E−01 | 3.53E−02 | 7.20E−02 | 1.62E−02 |
| E | 8.00E−01 | −4.11E−01 | −1.64E−01 | −2.89E−01 | −3.36E−02 | −1.18E−01 | −2.63E−02 |
| F | 1.15E+00 | 5.74E−01 | 2.24E−01 | 3.09E−01 | 7.40E−03 | 1.17E−01 | 2.39E−02 |
| G | 1.18E+00 | −5.47E−01 | −2.06E−01 | −2.36E−01 | 1.51E−02 | −7.90E−02 | −1.44E−02 |
| H | −8.70E−01 | 3.63E−01 | 1.32E−01 | 1.31E−01 | −1.88E−02 | 3.78E−02 | 5.94E−03 |
| J | 4.65E−01 | −1.69E−01 | −6.05E−02 | −5.28E−02 | 1.13E−02 | −1.28E−02 | −1.71E−03 |
| K | −1.78E−01 | 5.40E−02 | 1.96E−02 | 1.52E−02 | −4.22E−03 | 3.03E−03 | 3.40E−04 |
| M | 4.76E−02 | −1.14E−02 | −4.38E−03 | −3.05E−03 | 1.02E−03 | −4.91E−04 | −4.54E−05 |
| N | −8.40E−03 | 1.47E−03 | 6.45E−04 | 4.03E−04 | −1.57E−04 | 5.19E−05 | 3.85E−06 |
| O | 8.80E−04 | −9.32E−05 | −5.62E−05 | −3.15E−05 | 1.39E−05 | −3.22E−06 | −1.86E−07 |
| P | −4.14E−05 | 1.40E−06 | 2.19E−06 | 1.10E−06 | −5.44E−07 | 8.87E−08 | 3.81E−09 |

| Surface | | | | | | |
|---|---|---|---|---|---|---|
| No. | S15 | S16 | S17 | S18 | S19 | S20 |
| K | 1.24E+01 | 9.90E+01 | −1.39E+01 | −1.16E+01 | 7.13E+01 | −1.27E+01 |
| A | −9.13E−03 | −3.72E−02 | 5.61E−02 | 4.68E−02 | −1.26E−01 | −6.38E−02 |
| B | −1.40E−02 | −1.77E−02 | −6.70E−02 | −3.07E−02 | 5.42E−02 | 2.34E−02 |
| C | 2.92E−02 | 4.20E−02 | 4.85E−02 | 1.13E−02 | −2.00E−02 | −6.62E−03 |
| D | −3.61E−02 | −4.07E−02 | −2.75E−02 | −3.45E−03 | 6.36E−03 | 1.46E−03 |
| E | 2.97E−02 | 2.59E−02 | 1.18E−02 | 1.03E−03 | −1.57E−03 | −2.44E−04 |
| F | −1.74E−02 | −1.18E−02 | −3.74E−03 | −2.95E−04 | 2.84E−04 | 2.97E−05 |
| G | 7.44E−03 | 3.93E−03 | 8.71E−04 | 7.00E−05 | −3.71E−05 | −2.49E−06 |
| H | −2.33E−03 | −9.62E−04 | −1.47E−04 | −1.22E−05 | 3.49E−06 | 1.33E−07 |
| J | 5.34E−04 | 1.71E−04 | 1.79E−05 | 1.50E−06 | −2.36E−07 | −3.54E−09 |
| K | −8.78E−05 | −2.18E−05 | −1.54E−06 | −1.27E−07 | 1.13E−08 | −4.13E−11 |
| M | 1.01E−05 | 1.92E−06 | 9.14E−08 | 7.32E−09 | −3.78E−10 | 7.07E−12 |
| Z | −7.67E−07 | −1.12E−07 | −3.55E−09 | −2.71E−10 | 8.33E−12 | −2.56E−13 |
| O | 3.45E−08 | 3.84E−09 | 8.12E−11 | 5.80E−12 | −1.09E−13 | 4.35E−15 |
| P | −6.94E−10 | −5.90E−11 | −8.29E−13 | −5.47E−14 | 6.40E−16 | −3.00E−17 |

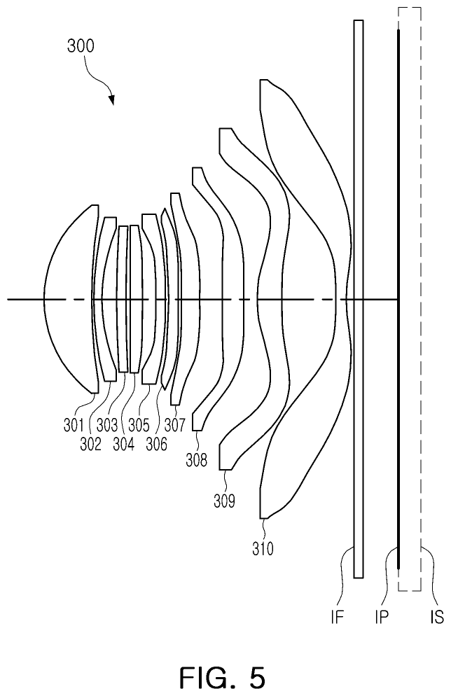

An example optical imaging system according to a third example embodiment will be described with reference to FIG. 5.

Referring to FIG. 5, an example optical imaging system 300 may include a first lens 301, a second lens 302, a third lens 303, a fourth lens 304, a fifth lens 305, a sixth lens 306, a seventh lens 307, an eighth lens 308, a ninth lens 309, and a tenth lens 310.

The first lens 301 may have positive refractive power, and may have a convex object-side surface and a concave image-side surface. The second lens 302 may have negative refractive power, and may have a convex object-side surface and a concave image-side surface. The third lens 303 may have positive refractive power, and may have a convex object-side surface and a concave image-side surface. The fourth lens 304 may have positive refractive power, and may have a convex object-side surface and a concave image-side surface. The fifth lens 305 may have positive refractive power, and may have a concave object-side surface and a convex image-side surface. The sixth lens 306 may have negative refractive power, and may have a concave object-side surface and a concave image-side surface. The seventh lens 307 may have positive refractive power, and may have a convex object-side surface and a convex image-side surface. In addition, the object-side surface and image-side surface of the seventh lens 307 may have an inflection point. The eighth lens 308 may have negative refractive power, and may have a convex object-side surface and a concave image-side surface. In addition, the object-side surface and image-side surface of the eighth lens 308 may have an inflection point. The ninth lens 309 may have positive refractive power, and may have a convex object-side surface and a concave image-side surface. In addition, the object-side surface and image-side surface of the ninth lens 309 may have an inflection point. The tenth lens 310 may have negative refractive power, and may have a concave object-side surface and a concave image-side surface. In addition, the object-side surface and image-side surface of the tenth lens 310 may have an inflection point.

The optical imaging system 300 may further include a filter IF and an image plane IP. The filter IF may be disposed between a tenth lens 310 and the image plane IP. In an example, the filter IF may be omitted, as necessary. The image plane IP may be formed on one surface or an inside of an image sensor IS of a camera module. However, a position of the image plane IP is not limited to the one surface or the inside of the image sensor IS.

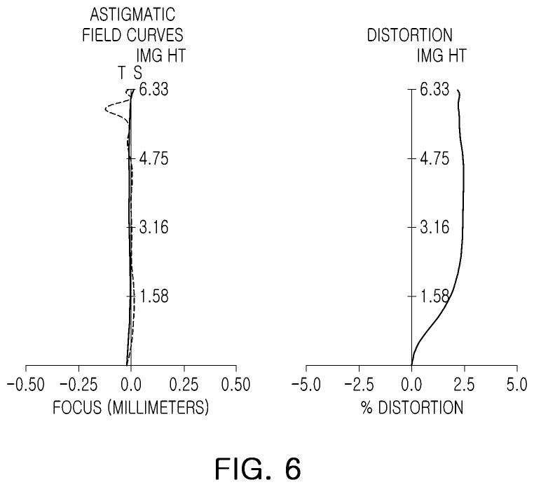

Tables 5 and 6 below illustrate lens properties and aspherical surface values of the example optical imaging system according to the present example embodiment. FIG. 6 is an aberration curve of the example optical imaging system according to the present example embodiment.

TABLE 5

| Surface | | Radius of | Thickness/ | Refractive | Abbe |
|---|---|---|---|---|---|
| No. | Component | Curvature | Distance | Index | Number |
| S1 | First lens | 2.7610 | 1.0760 | 1.544 | 56.0 |
| S2 | | 13.7062 | 0.0500 | | |
| S3 | Second lens | 6.4622 | 0.2000 | 1.671 | 19.4 |
| S4 | | 3.9039 | 0.3436 | | |
| S5 | Third lens | 14.4437 | 0.2104 | 1.544 | 56.0 |
| S6 | | 23.2944 | 0.0858 | | |
| S7 | Fourth lens | 125.0153 | 0.2786 | 1.544 | 56.0 |
| S8 | | 197.3572 | 0.3010 | | |
| S9 | Fifth lens | −25.8474 | 0.2108 | 1.671 | 19.4 |
| S10 | | −12.9877 | 0.0712 | | |
| S11 | Sixth lens | −11.3982 | 0.2019 | 1.651 | 21.5 |
| S12 | | 61.8435 | 0.0827 | | |
| S13 | Seventh lens | 53.2526 | 0.4172 | 1.544 | 56.0 |
| S14 | | −28.7375 | 0.5063 | | |
| S15 | Eighth lens | 14.7340 | 0.4666 | 1.567 | 37.4 |
| S16 | | 14.4344 | 0.3272 | | |
| S17 | Ninth lens | 3.0601 | 0.5549 | 1.544 | 56.0 |
| S18 | | 14.3801 | 1.2287 | | |
| S19 | Tenth lens | −239.1232 | 0.2239 | 1.535 | 55.7 |
| S20 | | 2.6701 | 0.1632 | | |
| S21 | Filter | Infinity | 0.2100 | 1.517 | 64.2 |
| S22 | | Infinity | 0.7701 | | |
| S23 | Image plane | Infinity | 0.0199 | | |

TABLE 6

| | Surface No. | | | | | | |
|---|---|---|---|---|---|---|---|
| | S1 | S2 | S3 | S4 | S5 | S6 | S7 |
| K | −3.31E−01 | 1.74E+01 | −1.61E+01 | −4.96E+00 | 1.26E−01 | −8.09E+01 | −9.90E+01 |
| A | 8.80E−04 | 1.62E−02 | 1.25E−02 | 4.91E−03 | −3.20E−03 | 4.31E−03 | −2.34E−04 |
| B | 1.39E−02 | −4.83E−02 | −5.79E−02 | −4.13E−02 | −1.51E−02 | −8.85E−03 | −1.43E−03 |
| C | −4.32E−02 | 9.57E−02 | 1.20E−01 | 1.52E−01 | 4.32E−02 | −8.30E−03 | −5.20E−04 |
| D | 8.83E−02 | −1.48E−01 | −1.93E−01 | −4.38E−01 | −1.76E−01 | 4.31E−02 | −3.08E−02 |
| E | −1.21E−01 | 1.77E−01 | 2.53E−01 | 9.25E−01 | 4.90E−01 | −8.05E−02 | 1.62E−01 |
| F | 1.15E−01 | −1.60E−01 | −2.53E−01 | −1.39E+00 | −8.97E−01 | 9.61E−02 | −3.83E−01 |
| G | −7.78E−02 | 1.07E−01 | 1.88E−01 | 1.49E+00 | 1.12E+00 | −7.72E−02 | 5.50E−01 |
| H | 3.82E−02 | −5.31E−02 | −1.04E−01 | −1.16E+00 | −9.89E−01 | 4.23E−02 | −5.25E−01 |
| J | −1.35E−02 | 1.93E−02 | 4.20E−02 | 6.50E−01 | 6.15E−01 | −1.59E−02 | 3.44E−01 |
| K | 3.43E−03 | −5.04E−03 | −1.23E−02 | −2.61E−01 | −2.69E−01 | 4.08E−03 | −1.56E−01 |
| M | −6.08E−04 | 9.26E−04 | 2.52E−03 | 7.28E−02 | 8.09E−02 | −7.05E−04 | 4.84E−02 |
| N | 7.13E−05 | −1.13E−04 | −3.45E−04 | −1.34E−02 | −1.59E−02 | 7.84E−05 | −9.75E−03 |
| O | −4.96E−06 | 8.23E−06 | 2.83E−05 | 1.46E−03 | 1.85E−03 | −5.06E−06 | 1.15E−03 |
| P | 1.56E−07 | −2.70E−07 | −1.05E−06 | −7.16E−05 | −9.56E−05 | 1.44E−07 | −6.09E−05 |
| | Surface No. | | | | | | |
| | S8 | S9 | S10 | S11 | S12 | S13 | S14 |
| K | 9.90E+01 | 6.46E+01 | 2.41E+01 | 7.21E+00 | −5.23E+01 | 1.11E+01 | −8.72E+01 |
| A | −6.98E−03 | −1.60E−02 | 7.38E−03 | −1.12E−04 | −1.07E−02 | −8.56E−03 | −1.17E−02 |
| B | −3.10E−02 | 6.05E−03 | −1.26E−02 | 1.77E−02 | −6.39E−03 | −2.36E−02 | −1.53E−02 |
| C | 1.56E−01 | −8.88E−02 | −4.83E−03 | −8.37E−02 | 3.63E−03 | 2.14E−02 | 7.73E−03 |
| D | −5.08E−01 | 2.95E−01 | 5.75E−02 | 2.08E−01 | −1.07E−02 | −2.12E−03 | 7.16E−03 |
| E | 1.10E+00 | −5.95E−01 | −1.30E−01 | −3.31E−01 | 3.63E−02 | −2.24E−02 | −1.99E−02 |
| F | −1.66E+00 | 7.95E−01 | 1.72E−01 | 3.63E−01 | −6.30E−02 | 3.61E−02 | 2.16E−02 |
| G | 1.78E+00 | −7.34E−01 | −1.52E−01 | −2.85E−01 | 6.58E−02 | −3.20E−02 | −1.43E−02 |
| H | −1.37E+00 | 4.75E−01 | 9.45E−02 | 1.63E−01 | −4.55E−02 | 1.84E−02 | 6.31E−03 |
| J | 7.60E−01 | −2.15E−01 | −4.16E−02 | −6.72E−02 | 2.17E−02 | −7.14E−03 | −1.90E−03 |
| K | −3.02E−01 | 6.70E−02 | 1.30E−02 | 1.99E−02 | −7.22E−03 | 1.88E−03 | 3.91E−04 |
| M | 8.36E−02 | −1.37E−02 | −2.80E−03 | −4.11E−03 | 1.64E−03 | −3.32E−04 | −5.38E−05 |
| N | −1.53E−02 | 1.67E−03 | 3.96E−04 | 5.59E−04 | −2.43E−04 | 3.76E−05 | 4.68E−06 |
| O | 1.66E−03 | −9.60E−05 | −3.31E−05 | −4.51E−05 | 2.11E−05 | −2.47E−06 | −2.31E−07 |
| P | −8.08E−05 | 7.07E−07 | 1.23E−06 | 1.63E−06 | −8.14E−07 | 7.17E−08 | 4.83E−09 |

| | Surface No. | | | | | |
|---|---|---|---|---|---|---|
| | S15 | S16 | S17 | S18 | S19 | S20 |
| K | −1.91E+00 | −9.90E+01 | −1.33E+01 | −5.55E+00 | 9.90E+01 | −1.15E+01 |
| A | −4.24E−03 | −2.67E−02 | 6.18E−02 | 5.44E−02 | −1.12E−01 | −5.66E−02 |
| B | −2.51E−02 | −4.13E−02 | −7.36E−02 | −3.60E−02 | 3.66E−02 | 1.42E−02 |
| C | 4.30E−02 | 6.89E−02 | 5.21E−02 | 1.20E−02 | −9.12E−03 | −1.34E−03 |
| D | −4.74E−02 | −6.15E−02 | −2.86E−02 | −2.36E−03 | 2.16E−03 | −3.61E−04 |
| E | 3.64E−02 | 3.79E−02 | 1.20E−02 | 1.88E−04 | −4.80E−04 | 1.71E−04 |
| F | −2.05E−02 | −1.71E−02 | −3.81E−03 | 1.55E−05 | 8.71E−05 | −3.63E−05 |
| G | 8.61E−03 | 5.71E−03 | 8.95E−04 | −2.94E−06 | −1.17E−05 | 4.97E−06 |
| H | −2.68E−03 | −1.41E−03 | −1.54E−04 | −5.25E−07 | 1.13E−06 | −4.75E−07 |
| J | 6.14E−04 | 2.54E−04 | 1.91E−05 | 1.91E−07 | −7.74E−08 | 3.22E−08 |
| K | −1.02E−04 | −3.28E−05 | −1.68E−06 | −2.46E−08 | 3.69E−09 | −1.55E−09 |
| M | 1.18E−05 | 2.95E−06 | 1.02E−07 | 1.76E−09 | −1.20E−10 | 5.12E−11 |
| N | −9.02E−07 | −1.74E−07 | −4.04E−09 | −7.29E−11 | 2.51E−12 | −1.11E−12 |
| O | 4.10E−08 | 6.09E−09 | 9.44E−11 | 1.65E−12 | −3.04E−14 | 1.42E−14 |
| P | −8.33E−10 | −9.52E−11 | −9.83E−13 | −1.58E−14 | 1.61E−16 | −8.10E−17 |

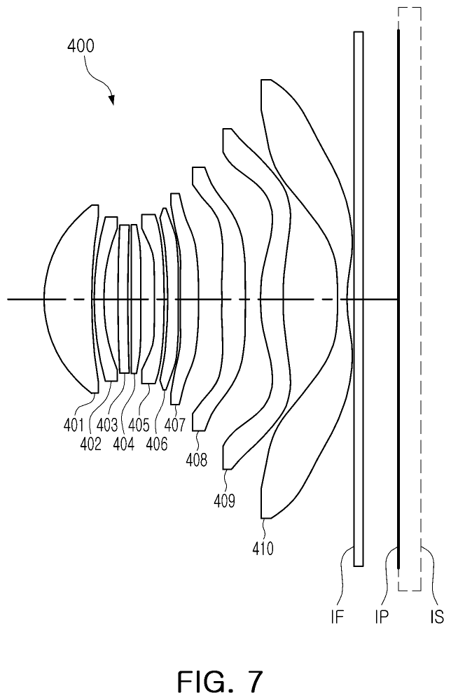

An example optical imaging system according to a fourth example embodiment will be described with reference to FIG. 7.

Referring to FIG. 7, an example optical imaging system 400 may include a first lens 401, a second lens 402, a third lens 403, a fourth lens 404, a fifth lens 405, a sixth lens 406, a seventh lens 407, an eighth lens 408, a ninth lens 409, and a tenth lens 410.

The first lens 401 may have positive refractive power, and may have a convex object-side surface and a concave image-side surface. The second lens 402 may have negative refractive power, and may have a convex object-side surface and a concave image-side surface. The third lens 403 may have positive refractive power, and may have a convex object-side surface and a concave image-side surface. The fourth lens 404 may have negative refractive power, and may have a convex object-side surface and a concave image-side surface. The fifth lens 405 may have positive refractive power, and may have a concave object-side surface and a convex image-side surface. The sixth lens 406 may have negative refractive power, and may have a concave object-side surface and a concave image-side surface. The seventh lens 407 may have positive refractive power, and may have a convex object-side surface and a convex image-side surface. Additionally, the object-side surface and image-side surface of the seventh lens 407 may have an inflection point. The eighth lens 408 may have positive refractive power, and may have a convex object-side surface and a concave image-side surface. Additionally, the object-side surface and image-side surface of the eighth lens 408 may have an inflection point. The ninth lens 409 may have positive refractive power, and may have a convex object-side surface and a concave image-side surface. Additionally, the object-side surface and image-side surface of the ninth lens 409 may have an inflection point. The tenth lens 410 may have negative refractive power, and may have a concave object-side surface and a concave image-side surface. Additionally, the object-side surface and image-side surface of the tenth lens 410 may have an inflection point.

The optical imaging system 400 may further include a filter IF and an image plane IP. The filter IF may be disposed between a tenth lens 410 and the image plane IP. In an example, the filter IF may be omitted, as necessary. The image plane IP may be formed on one surface or an inside of an image sensor IS of a camera module. However, a position of the image plane IP is not limited to the one surface or the inside of the image sensor IS.

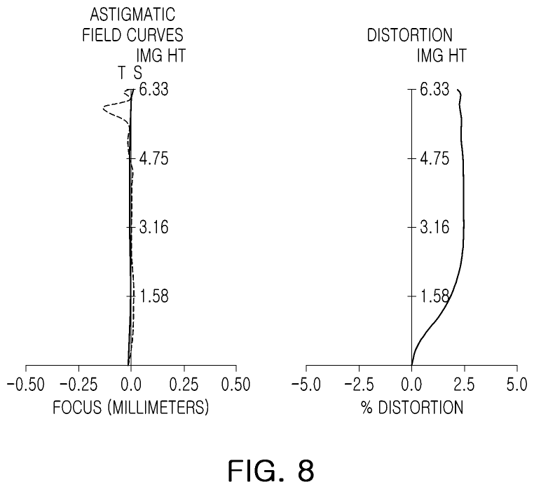

Tables 7 and 8 below illustrate lens properties and aspherical surface values of the example optical imaging system according to the present example embodiment. FIG. 8 is an aberration curve of the optical imaging system according to the present example embodiment.

TABLE 7

| Surface | | Radius of | Thickness/ | Refractive | Abbe |
|---|---|---|---|---|---|
| No. | Component | Curvature | Distance | Index | Number |
| S1 | First lens | 2.7621 | 1.0778 | 1.544 | 56.0 |
| S2 | | 13.7869 | 0.0500 | | |
| S3 | Second lens | 6.8469 | 0.2000 | 1.671 | 19.4 |
| S4 | | 4.0486 | 0.3427 | | |
| S5 | Third lens | 15.1520 | 0.2107 | 1.544 | 56.0 |
| S6 | | 27.5707 | 0.0865 | | |
| S7 | Fourth lens | 620.1336 | 0.2155 | 1.544 | 56.0 |
| S8 | | 609.5333 | 0.3160 | | |
| S9 | Fifth lens | −24.6535 | 0.2100 | 1.671 | 19.4 |
| S10 | | −13.2588 | 0.0694 | | |
| S11 | Sixth lens | −11.6647 | 0.2054 | 1.651 | 21.5 |
| S12 | | 61.8590 | 0.0752 | | |
| S13 | Seventh | 42.6216 | 0.4190 | 1.544 | 56.0 |
| | lens | | | | |
| S14 | | −36.3494 | 0.5156 | | |
| S15 | Eighth lens | 13.9924 | 0.5394 | 1.567 | 37.4 |
| S16 | | 18.2864 | 0.3417 | | |
| S17 | Ninth lens | 3.2052 | 0.5403 | 1.544 | 56.0 |
| S18 | | 14.8986 | 1.2208 | | |
| S19 | Tenth lens | −181.8901 | 0.2017 | 1.535 | 55.7 |
| S20 | | 2.6652 | 0.1625 | | |
| S21 | Filter | Infinity | 0.2100 | 1.517 | 64.2 |
| S22 | | Infinity | 0.7745 | | |
| S23 | Image plane | Infinity | 0.0155 | | |

TABLE 8

| | Surface No. | | | | | | |
|---|---|---|---|---|---|---|---|
| | S1 | S2 | S3 | S4 | S5 | S6 | S7 |
| K | −3.35E−01 | 1.67E+01 | −1.65E+01 | −4.97E+00 | −4.05E−01 | −9.12E+01 | −9.90E+01 |
| A | 1.50E−03 | 1.72E−02 | 1.46E−02 | 6.45E−03 | −2.12E−03 | 5.00E−03 | −2.00E−04 |
| B | 1.03E−02 | −5.43E−02 | −6.85E−02 | −4.62E−02 | −2.26E−02 | −9.23E−03 | −1.93E−03 |
| C | −3.18E−02 | 1.09E−01 | 1.51E−01 | 1.65E−01 | 8.17E−02 | −1.24E−02 | −2.57E−03 |
| D | 6.55E−02 | −1.68E−01 | −2.62E−01 | −4.70E−01 | −3.15E−01 | 5.39E−02 | −1.66E−02 |
| E | −9.04E−02 | 1.98E−01 | 3.62E−01 | 9.82E−01 | 8.15E−01 | −9.69E−02 | 1.16E−01 |
| F | 8.68E−02 | −1.75E−01 | −3.78E−01 | −1.46E+00 | −1.41E+00 | 1.14E−01 | −2.87E−01 |
| G | −5.94E−02 | 1.15E−01 | 2.93E−01 | 1.56E+00 | 1.70E+00 | −9.15E−02 | 4.12E−01 |
| H | 2.93E−02 | −5.56E−02 | −1.68E−01 | −1.21E+00 | −1.44E+00 | 5.04E−02 | −3.87E−01 |
| J | −1.05E−02 | 1.98E−02 | 7.02E−02 | 6.75E−01 | 8.71E−01 | −1.91E−02 | 2.47E−01 |
| K | 2.67E−03 | −5.07E−03 | −2.13E−02 | −2.70E−01 | −3.72E−01 | 4.99E−03 | −1.09E−01 |
| M | −4.76E−04 | 9.13E−04 | 4.53E−03 | 7.49E−02 | 1.10E−01 | −8.75E−04 | 3.24E−02 |
| N | 5.61E−05 | −1.10E−04 | −6.41E−04 | −1.37E−02 | −2.13E−02 | 9.88E−05 | −6.22E−03 |
| O | −3.93E−06 | 7.84E−06 | 5.42E−05 | 1.49E−03 | 2.43E−03 | −6.49E−06 | 6.98E−04 |
| P | 1.24E−07 | −2.54E−07 | −2.07E−06 | −7.27E−05 | −1.24E−04 | 1.88E−07 | −3.46E−05 |
| | Surface No. | | | | | | |
| | S8 | S9 | S10 | S11 | S12 | S13 | S14 |
| K | 9.90E+01 | 4.43E+01 | 2.56E+01 | 7.69E+00 | 2.50E+01 | 9.90E+01 | −9.19E+01 |
| A | −8.04E−03 | −1.49E−02 | 7.47E−03 | −2.48E−04 | −9.24E−03 | −8.80E−03 | −1.50E−02 |
| B | −2.67E−02 | 2.09E−03 | −1.11E−02 | 1.75E−02 | −1.17E−02 | −2.65E−02 | −1.37E−02 |
| C | 1.39E−01 | −7.37E−02 | −8.89E−03 | −8.17E−02 | 1.19E−02 | 3.07E−02 | 1.02E−02 |
| D | −4.69E−01 | 2.54E−01 | 6.30E−02 | 2.02E−01 | −1.66E−02 | −1.74E−02 | 1.41E−03 |
| E | 1.05E+00 | −5.22E−01 | −1.37E−01 | −3.19E−01 | 3.42E−02 | −4.37E−03 | −1.29E−02 |
| F | −1.63E+00 | 7.11E−01 | 1.79E−01 | 3.49E−01 | −5.28E−02 | 1.99E−02 | 1.59E−02 |
| G | 1.78E+00 | −6.68E−01 | −1.58E−01 | −2.72E−01 | 5.32E−02 | −2.12E−02 | −1.10E−02 |
| H | −1.39E+00 | 4.41E−01 | 9.83E−02 | 1.54E−01 | −3.62E−02 | 1.32E−02 | 4.95E−03 |
| J | 7.83E−01 | −2.06E−01 | −4.33E−02 | −6.32E−02 | 1.71E−02 | −5.37E−03 | −1.50E−03 |
| K | −3.14E−01 | 6.66E−02 | 1.35E−02 | 1.86E−02 | −5.66E−03 | 1.46E−03 | 3.08E−04 |
| M | 8.74E−02 | −1.45E−02 | −2.89E−03 | −3.80E−03 | 1.28E−03 | −2.64E−04 | −4.18E−05 |
| N | −1.60E−02 | 1.96E−03 | 4.07E−04 | 5.13E−04 | −1.89E−04 | 3.04E−05 | 3.55E−06 |
| O | 1.74E−03 | −1.43E−04 | −3.38E−05 | −4.11E−05 | 1.64E−05 | −2.03E−06 | −1.68E−07 |
| P | −8.50E−05 | 3.70E−06 | 1.25E−06 | 1.47E−06 | −6.30E−07 | 5.98E−08 | 3.27E−09 |

| | Surface No. | | | | | |
|---|---|---|---|---|---|---|
| | S15 | S16 | S17 | S18 | S19 | S20 |
| K | −3.12E+00 | −6.10E+01 | −1.34E+01 | −7.35E+00 | 9.90E+01 | −1.12E+01 |
| A | −5.05E−03 | −2.31E−02 | 6.11E−02 | 5.56E−02 | −1.13E−01 | −5.85E−02 |
| B | −2.24E−02 | −3.87E−02 | −6.93E−02 | −3.71E−02 | 3.66E−02 | 1.53E−02 |
| C | 3.61E−02 | 5.82E−02 | 4.60E−02 | 1.23E−02 | −8.99E−03 | −1.75E−03 |
| D | −3.87E−02 | −4.82E−02 | −2.39E−02 | −2.38E−03 | 2.12E−03 | −2.25E−04 |
| E | 2.94E−02 | 2.78E−02 | 9.61E−03 | 2.16E−04 | −4.73E−04 | 1.35E−04 |
| F | −1.66E−02 | −1.19E−02 | −2.95E−03 | −4.24E−06 | 8.65E−05 | −2.91E−05 |
| G | 7.06E−03 | 3.78E−03 | 6.77E−04 | 3.37E−06 | −1.17E−05 | 3.97E−06 |
| H | −2.24E−03 | −8.95E−04 | −1.14E−04 | −1.71E−06 | 1.12E−06 | −3.77E−07 |
| J | 5.24E−04 | 1.56E−04 | 1.38E−05 | 3.36E−07 | −7.61E−08 | 2.54E−08 |
| K | −8.87E−05 | −1.95E−05 | −1.19E−06 | −3.66E−08 | 3.59E−09 | −1.21E−09 |
| M | 1.05E−05 | 1.70E−06 | 7.03E−08 | 2.41E−09 | −1.15E−10 | 4.00E−11 |
| N | −8.24E−07 | −9.81E−08 | −2.73E−09 | −9.64E−11 | 2.38E−12 | −8.64E−13 |
| O | 3.83E−08 | 3.34E−09 | 6.24E−11 | 2.14E−12 | −2.84E−14 | 1.10E−14 |
| P | −7.95E−10 | −5.10E−11 | −6.36E−13 | −2.03E−14 | 1.47E−16 | −6.24E−17 |

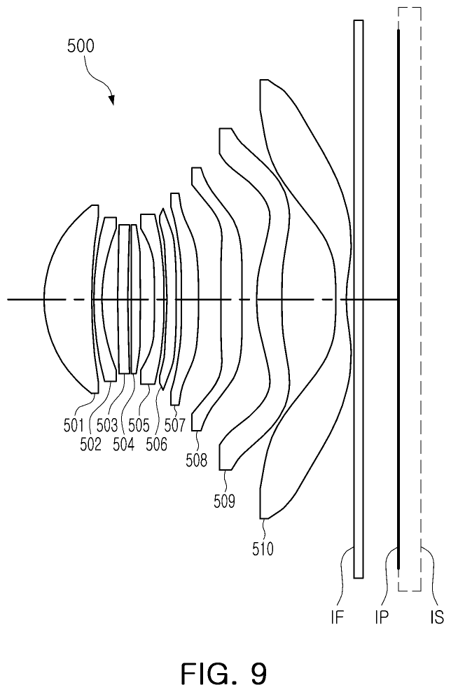

An example optical imaging system according to a fifth example embodiment will be described with reference to FIG. 9.

Referring to FIG. 9, an example optical imaging system 500 may include a first lens 501, a second lens 502, a third lens 503, a fourth lens 504, a fifth lens 505, a sixth lens 506, a seventh lens 507, an eighth lens 508, a ninth lens 509, and a tenth lens 510.

The first lens 501 may have positive refractive power, and may have a convex object-side surface and a concave image-side surface. The second lens 502 may have negative refractive power, and may have a convex object-side surface and a concave image-side surface. The third lens 503 may have positive refractive power, and may have a convex object-side surface and a concave image-side surface. The fourth lens 504 may have positive refractive power, and may have a convex object-side surface and a concave image-side surface. The fifth lens 505 may have positive refractive power, and may have a concave object-side surface and a convex image-side surface. The sixth lens 506 may have negative refractive power, and may have a concave object-side surface and a concave image-side surface. The seventh lens 507 may have positive refractive power, and may have a convex object-side surface and a convex image-side surface. In addition, the object-side surface and image-side surface of the seventh lens 507 may have an inflection point. The eighth lens 508 may have negative refractive power, and may have a convex object-side surface and a concave image-side surface. Additionally, the object-side surface and image-side surface of the eighth lens 508 may have an inflection point. The ninth lens 509 may have positive refractive power, and may have a convex object-side surface and a concave image-side surface. Additionally, the object-side surface and image-side surface of the ninth lens 509 may have an inflection point. The tenth lens 510 may have negative refractive power, and may have a concave object-side surface and a concave image-side surface. Additionally, the object-side surface and image-side surface of the tenth lens 510 may have an inflection point.

The optical imaging system 500 may further include a filter IF and an image plane IP. The filter IF may be disposed between a tenth lens 510 and the image plane IP. In an example, the filter IF may be omitted, as necessary. The image plane IP may be formed on one surface or an inside of an image sensor IS of a camera module. However, a position of the image plane IP is not limited to the one surface or the inside of the image sensor IS.

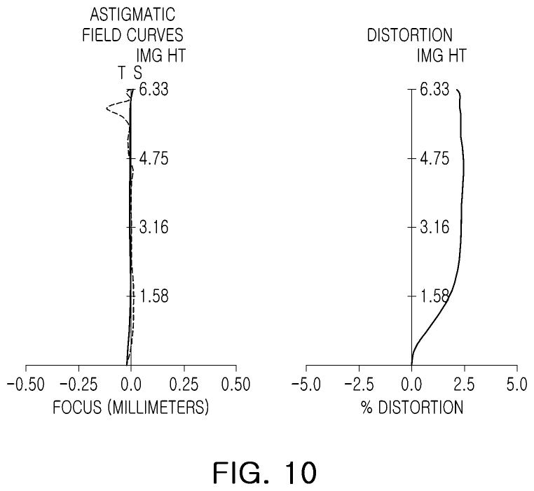

Tables 9 and 10 below illustrate lens properties and aspherical surface values of the example optical imaging system according to the present example embodiment. FIG. 10 is an aberration curve of the optical imaging system according to the present example embodiment.

TABLE 9

| Surface | | Radius of | Thickness/ | Refractive | Abbe |
|---|---|---|---|---|---|
| No. | Component | Curvature | Distance | Index | Number |
| S1 | First lens | 2.7580 | 1.0829 | 1.544 | 56.0 |
| S2 | | 13.6955 | 0.0500 | | |
| S3 | Second lens | 6.8718 | 0.2000 | 1.671 | 19.4 |
| S4 | | 4.0381 | 0.3445 | | |
| S5 | Third lens | 14.5969 | 0.2080 | 1.544 | 56.0 |
| S6 | | 19.9230 | 0.0898 | | |
| S7 | Fourth lens | 67.7211 | 0.2157 | 1.544 | 56.0 |
| S8 | | 383.8434 | 0.3113 | | |
| S9 | Fifth lens | −25.6688 | 0.2104 | 1.671 | 19.4 |
| S10 | | −12.9720 | 0.0715 | | |
| S11 | Sixth lens | −11.2801 | 0.2037 | 1.651 | 21.5 |
| S12 | | 61.9263 | 0.0879 | | |
| S13 | Seventh lens | 48.1263 | 0.4182 | 1.544 | 56.0 |
| S14 | | −31.9971 | 0.5102 | | |
| S15 | Eighth lens | 14.5186 | 0.4673 | 1.567 | 37.4 |
| S16 | | 14.1366 | 0.3284 | | |
| S17 | Ninth lens | 3.0380 | 0.5603 | 1.544 | 56.0 |
| S18 | | 14.0973 | 1.2361 | | |
| S19 | Tenth lens | −257.3225 | 0.2388 | 1.535 | 55.7 |
| S20 | | 2.6753 | 0.1651 | | |
| S21 | Filter | Infinity | 0.2100 | 1.517 | 64.2 |
| S22 | | Infinity | 0.7700 | | |
| S23 | Image plane | Infinity | 0.0200 | | |

TABLE 10

| | Surface No. | | | | | | |
|---|---|---|---|---|---|---|---|
| | S1 | S2 | S3 | S4 | S5 | S6 | S7 |
| K | −3.29E−01 | 1.74E+01 | −1.58E+01 | −4.85E+00 | −2.70E+00 | −4.46E+01 | −9.90E+01 |
| A | 8.92E−04 | 1.54E−02 | 1.12E−02 | 3.89E−03 | −3.05E−03 | 4.37E−03 | −4.54E−05 |
| B | 1.37E−02 | −4.58E−02 | −5.45E−02 | −3.61E−02 | −2.39E−02 | −6.96E−03 | −1.08E−03 |
| C | −4.25E−02 | 9.09E−02 | 1.16E−01 | 1.34E−01 | 9.12E−02 | −1.35E−02 | −6.52E−04 |
| D | 8.70E−02 | −1.42E−01 | −1.97E−01 | −3.99E−01 | −3.39E−01 | 5.28E−02 | −2.82E−02 |
| E | −1.19E−01 | 1.71E−01 | 2.70E−01 | 8.68E−01 | 8.55E−01 | −9.32E−02 | 1.42E−01 |
| F | 1.13E−01 | −1.54E−01 | −2.82E−01 | −1.34E+00 | −1.46E+00 | 1.08E−01 | −3.26E−01 |
| G | −7.67E−02 | 1.03E−01 | 2.19E−01 | 1.47E+00 | 1.75E+00 | −8.51E−02 | 4.54E−01 |
| H | 3.75E−02 | −5.05E−02 | −1.25E−01 | −1.16E+00 | −1.48E+00 | 4.61E−02 | −4.20E−01 |
| J | −1.33E−02 | 1.81E−02 | 5.24E−02 | 6.65E−01 | 8.99E−01 | −1.72E−02 | 2.67E−01 |
| K | 3.35E−03 | −4.68E−03 | −1.59E−02 | −2.71E−01 | −3.85E−01 | 4.41E−03 | −1.17E−01 |
| M | −5.90E−04 | 8.49E−04 | 3.38E−03 | 7.65E−02 | 1.14E−01 | −7.63E−04 | 3.50E−02 |
| N | 6.87E−05 | −1.02E−04 | −4.79E−04 | −1.42E−02 | −2.22E−02 | 8.50E−05 | −6.77E−03 |
| O | −4.76E−06 | 7.37E−06 | 4.06E−05 | 1.57E−03 | 2.55E−03 | −5.50E−06 | 7.68E−04 |
| P | 1.48E−07 | −2.39E−07 | −1.55E−06 | −7.75E−05 | −1.31E−04 | 1.58E−07 | −3.85E−05 |
| | Surface No. | | | | | | |
| | S8 | S9 | S10 | S11 | S12 | S13 | S14 |
| K | 9.90E+01 | 5.17E+01 | 2.33E+01 | 6.70E+00 | −1.68E+01 | 7.43E+01 | −9.11E+01 |
| A | −7.78E−03 | −1.66E−02 | 7.16E−03 | −1.08E−04 | −1.07E−02 | −1.01E−02 | −1.20E−02 |
| B | −3.20E−02 | 8.85E−03 | −1.25E−02 | 1.79E−02 | −9.07E−03 | −2.03E−02 | −1.47E−02 |
| C | 1.66E−01 | −1.02E−01 | −4.04E−03 | −8.50E−02 | 1.49E−02 | 1.63E−02 | 6.93E−03 |
| D | −5.56E−01 | 3.37E−01 | 5.60E−02 | 2.12E−01 | −3.56E−02 | 5.02E−03 | 8.50E−03 |
| E | 1.24E+00 | −6.76E−01 | −1.29E−01 | −3.38E−01 | 7.28E−02 | −2.97E−02 | −2.13E−02 |
| F | −1.91E+00 | 9.00E−01 | 1.71E−01 | 3.73E−01 | −1.01E−01 | 4.08E−02 | 2.24E−02 |
| G | 2.09E+00 | −8.26E−01 | −1.51E−01 | −2.94E−01 | 9.41E−02 | −3.39E−02 | −1.46E−02 |
| H | −1.64E+00 | 5.30E−01 | 9.39E−02 | 1.68E−01 | −6.09E−02 | 1.88E−02 | 6.35E−03 |
| J | 9.26E−01 | −2.38E−01 | −4.14E−02 | −6.97E−02 | 2.78E−02 | −7.15E−03 | −1.89E−03 |
| K | −3.74E−01 | 7.27E−02 | 1.29E−02 | 2.07E−02 | −8.92E−03 | 1.86E−03 | 3.85E−04 |
| M | 1.05E−01 | −1.44E−02 | −2.78E−03 | −4.29E−03 | 1.97E−03 | −3.27E−04 | −5.23E−05 |
| N | −1.95E−02 | 1.63E−03 | 3.93E−04 | 5.86E−04 | −2.86E−04 | 3.69E−05 | 4.50E−06 |
| O | 2.14E−03 | −7.39E−05 | −3.27E−05 | −4.75E−05 | 2.44E−05 | −2.42E−06 | −2.19E−07 |
| P | −1.06E−04 | −1.25E−06 | 1.21E−06 | 1.72E−06 | −9.32E−07 | 7.04E−08 | 4.52E−09 |

| | Surface No. | | | | | |
|---|---|---|---|---|---|---|
| | S15 | S16 | S17 | S18 | S19 | S20 |
| K | −1.97E+00 | −9.90E+01 | −1.30E+01 | −5.29E+00 | −9.90E+01 | −1.14E+01 |
| A | −3.86E−03 | −2.64E−02 | 6.12E−02 | 5.34E−02 | −1.10E−01 | −5.42E−02 |
| B | −2.60E−02 | −4.12E−02 | −7.23E−02 | −3.56E−02 | 3.28E−02 | 1.18E−02 |
| C | 4.34E−02 | 6.80E−02 | 5.09E−02 | 1.25E−02 | −6.34E−03 | 5.70E−06 |
| D | −4.67E−02 | −6.04E−02 | −2.77E−02 | −2.91E−03 | 8.86E−04 | −8.44E−04 |
| E | 3.51E−02 | 3.71E−02 | 1.14E−02 | 4.17E−04 | −1.00E−04 | 2.87E−04 |
| F | −1.96E−02 | −1.67E−02 | −3.55E−03 | −3.71E−05 | 1.13E−05 | −5.54E−05 |
| G | 8.14E−03 | 5.56E−03 | 8.19E−04 | 3.90E−06 | −1.24E−06 | 7.20E−06 |
| H | −2.53E−03 | −1.37E−03 | −1.38E−04 | −8.98E−07 | 1.02E−07 | −6.61E−07 |
| J | 5.80E−04 | 2.47E−04 | 1.69E−05 | 1.63E−07 | −4.91E−09 | 4.34E−08 |
| K | −9.63E−05 | −3.19E−05 | −1.47E−06 | −1.77E−08 | 6.86E−11 | −2.02E−09 |
| M | 1.12E−05 | 2.87E−06 | 8.84E−08 | 1.15E−09 | 6.04E−12 | 6.51E−11 |
| N | −8.62E−07 | −1.70E−07 | −3.48E−09 | −4.40E−11 | −3.80E−13 | −1.38E−12 |
| O | 3.93E−08 | 5.93E−09 | 8.04E−11 | 9.12E−13 | 9.04E−15 | 1.73E−14 |
| P | −8.03E−10 | −9.26E−11 | −8.30E−13 | −7.75E−15 | −8.22E−17 | −9.68E−17 |

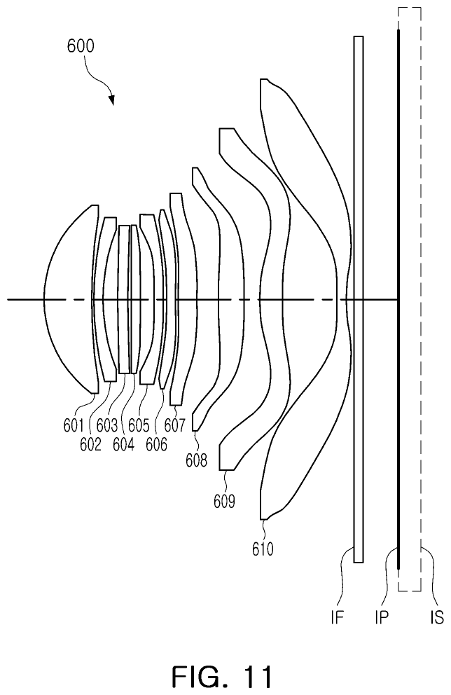

An example optical imaging system according to a sixth example embodiment will be described with reference to FIG. 11.

An example optical imaging system 600 may include a first lens 601, a second lens 602, a third lens 603, a fourth lens 604, a fifth lens 605, a sixth lens 606, a seventh lens 607, an eighth lens 608, a ninth lens 609, and a tenth lens 610.

The first lens 601 may have positive refractive power, and may have a convex object-side surface and a concave image-side surface. The second lens 602 may have negative refractive power, and may have a convex object-side surface and a concave image-side surface. The third lens 603 may have positive refractive power, and may have a convex object-side surface and a concave image-side surface. The fourth lens 604 may have negative refractive power, and may have a convex object-side surface and a concave image-side surface. The fifth lens 605 may have positive refractive power, and may have a concave object-side surface and a convex image-side surface. The sixth lens 606 may have negative refractive power, and may have a concave object-side surface and a concave image-side surface. The seventh lens 607 may have positive refractive power, and may have a convex object-side surface and a concave image-side surface. Additionally, the object-side surface and image-side surface of the seventh lens 607 may have an inflection point. The eighth lens 608 may have positive refractive power, and may have a convex object-side surface and a concave image-side surface. Additionally, the object-side surface and image-side surface of the eighth lens 608 may have an inflection point. The ninth lens 609 may have positive refractive power, and may have a convex object-side surface and a concave image-side surface. Additionally, the object-side surface and image-side surface of the ninth lens 609 may have an inflection point. The tenth lens 610 may have negative refractive power, and may have a concave object-side surface and a concave image-side surface. Additionally, the object-side surface and image-side surface of the tenth lens 610 may have an inflection point.

The optical imaging system 600 may further include a filter IF and an image plane IP. The filter IF may be disposed between a tenth lens 610 and the image plane IP. In an example, the filter IF may be omitted, as necessary. The image plane IP may be formed on one surface or an inside of an image sensor IS of a camera module. However, a position of the image plane IP is not limited to the one surface or the inside of the image sensor IS.

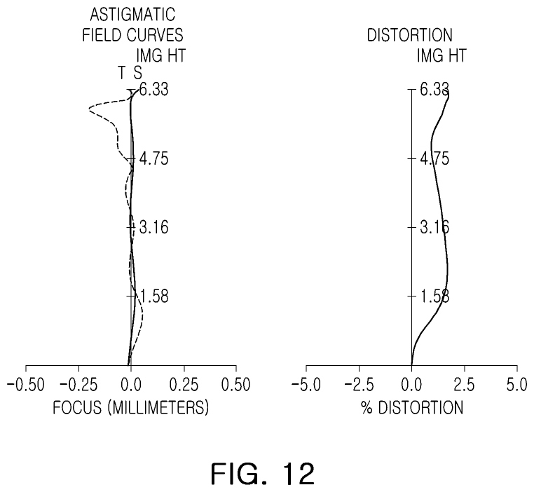

Tables 11 and 12 below illustrate lens properties and aspherical surface values of the example optical imaging system according to the present example embodiment. FIG. 12 is an aberration curve of the optical imaging system according to the present example embodiment.

TABLE 11

| Surface | | Radius of | Thickness/ | Refractive | Abbe |
|---|---|---|---|---|---|
| No. | Component | Curvature | Distance | Index | Number |
| S1 | First lens | 2.7608 | 1.0646 | 1.544 | 56.0 |
| S2 | | 13.6730 | 0.0515 | | |
| S3 | Second lens | 6.9556 | 0.2000 | 1.671 | 19.4 |
| S4 | | 4.0781 | 0.3389 | | |
| S5 | Third lens | 14.6870 | 0.2111 | 1.544 | 56.0 |
| S6 | | 25.8336 | 0.0866 | | |
| S7 | Fourth lens | 337.3429 | 0.2097 | 1.544 | 56.0 |
| S8 | | 327.3935 | 0.3085 | | |
| S9 | Fifth lens | −25.9472 | 0.2139 | 1.671 | 19.4 |
| S10 | | −12.9798 | 0.0719 | | |
| S11 | Sixth lens | −11.2777 | 0.2019 | 1.651 | 21.5 |
| S12 | | 58.2513 | 0.0647 | | |
| S13 | Seventh lens | 39.2572 | 0.4107 | 1.544 | 56.0 |
| S14 | | 476.0677 | 0.5025 | | |
| S15 | Eighth lens | 10.1946 | 0.5876 | 1.567 | 37.4 |
| S16 | | 645.9059 | 0.3562 | | |
| S17 | Ninth lens | 3.8184 | 0.5216 | 1.544 | 56.0 |
| S18 | | 13.8809 | 1.2218 | | |
| S19 | Tenth lens | −259.4370 | 0.2096 | 1.535 | 55.7 |
| S20 | | 2.6436 | 0.1641 | | |
| S21 | Filter | Infinity | 0.2100 | 1.517 | 64.2 |
| S22 | | Infinity | 0.7771 | | |
| S23 | Image plane | Infinity | 0.0098 | | |

TABLE 12

| | Surface No. | | | | | | |
|---|---|---|---|---|---|---|---|
| | S1 | S2 | S3 | S4 | S5 | S6 | S7 |
| K | −3.31E−01 | 1.79E+01 | −1.61E+01 | −4.93E+00 | 1.62E+00 | −8.52E+01 | 2.64E+00 |
| A | 7.95E−04 | 1.66E−02 | 1.37E−02 | 3.52E−03 | −1.20E−03 | 4.06E−03 | −2.99E−05 |
| B | 1.34E−02 | −5.00E−02 | −6.17E−02 | −2.94E−02 | −3.18E−02 | −2.44E−04 | −1.45E−03 |
| C | −3.98E−02 | 9.64E−02 | 1.34E−01 | 1.22E−01 | 1.33E−01 | −4.36E−02 | −5.76E−04 |
| D | 7.92E−02 | −1.47E−01 | −2.48E−01 | −4.21E−01 | −4.60E−01 | 1.16E−01 | −2.34E−02 |
| E | −1.06E−01 | 1.78E−01 | 3.77E−01 | 9.98E−01 | 1.02E+00 | −1.81E−01 | 1.23E−01 |
| F | 9.94E−02 | −1.62E−01 | −4.30E−01 | −1.59E+00 | −1.52E+00 | 1.93E−01 | −2.86E−01 |
| G | −6.67E−02 | 1.10E−01 | 3.56E−01 | 1.74E+00 | 1.60E+00 | −1.44E−01 | 3.97E−01 |
| H | 3.24E−02 | −5.43E−02 | −2.12E−01 | −1.36E+00 | −1.23E+00 | 7.49E−02 | −3.66E−01 |
| J | −1.14E−02 | 1.95E−02 | 9.16E−02 | 7.58E−01 | 6.88E−01 | −2.72E−02 | 2.31E−01 |
| K | 2.89E−03 | −5.00E−03 | −2.82E−02 | −3.00E−01 | −2.79E−01 | 6.84E−03 | −1.00E−01 |
| M | −5.11E−04 | 8.94E−04 | 6.03E−03 | 8.25E−02 | 7.94E−02 | −1.17E−03 | 2.97E−02 |
| N | 5.99E−05 | −1.06E−04 | −8.54E−04 | −1.50E−02 | −1.51E−02 | 1.29E−04 | −5.70E−03 |
| O | −4.19E−06 | 7.44E−06 | 7.19E−05 | 1.61E−03 | 1.71E−03 | −8.30E−06 | 6.39E−04 |
| P | 1.32E−07 | −2.35E−07 | −2.72E−06 | −7.79E−05 | −8.71E−05 | 2.37E−07 | −3.18E−05 |
| | Surface No. | | | | | | |
| | S8 | S9 | S10 | S11 | S12 | S13 | S14 |
| K | −4.15E+00 | 6.03E+01 | 2.39E+01 | 7.56E+00 | −1.41E+01 | 9.09E+01 | −5.62E+01 |
| A | −6.22E−03 | −8.08E−05 | 7.17E−03 | −2.02E−04 | −1.35E−02 | −6.73E−03 | 1.37E−02 |
| B | −5.44E−02 | −1.18E−01 | −1.16E−02 | 1.78E−02 | 1.44E−02 | −3.26E−02 | −1.37E−01 |
| C | 2.62E−01 | 4.81E−01 | −5.76E−03 | −8.41E−02 | −6.85E−02 | 4.00E−02 | 2.90E−01 |
| D | −7.97E−01 | −1.46E+00 | 5.56E−02 | 2.09E−01 | 1.45E−01 | −2.94E−02 | −4.03E−01 |
| E | 1.66E+00 | 3.09E+00 | −1.23E−01 | −3.34E−01 | −1.96E−01 | 1.37E−02 | 3.86E−01 |
| F | −2.44E+00 | −4.63E+00 | 1.60E−01 | 3.68E−01 | 1.84E−01 | −2.26E−03 | −2.62E−01 |
| G | 2.59E+00 | 4.97E+00 | −1.40E−01 | −2.90E−01 | −1.26E−01 | −3.03E−03 | 1.28E−01 |
| H | −1.99E+00 | −3.86E+00 | 8.57E−02 | 1.66E−01 | 6.30E−02 | 3.34E−03 | −4.54E−02 |
| J | 1.11E+00 | 2.16E+00 | −3.74E−02 | −6.87E−02 | −2.29E−02 | −1.75E−03 | 1.17E−02 |
| K | −4.41E−01 | −8.71E−01 | 1.16E−02 | 2.04E−02 | 5.95E−03 | 5.61E−04 | −2.17E−03 |
| M | 1.22E−01 | 2.44E−01 | −2.47E−03 | −4.24E−03 | −1.07E−03 | −1.14E−04 | 2.83E−04 |
| N | −2.24E−02 | −4.54E−02 | 3.47E−04 | 5.80E−04 | 1.26E−04 | 1.45E−05 | −2.45E−05 |
| O | 2.44E−03 | 5.02E−03 | −2.88E−05 | −4.71E−05 | −8.70E−06 | −1.04E−06 | 1.26E−06 |
| P | −1.19E−04 | −2.50E−04 | 1.07E−06 | 1.71E−06 | 2.65E−07 | 3.27E−08 | −2.96E−08 |

| | Surface No. | | | | | |
|---|---|---|---|---|---|---|
| | S15 | S16 | S17 | S18 | S19 | S20 |
| K | −5.17E+00 | −8.80E−01 | −1.42E+01 | −4.73E+00 | 8.46E+01 | −1.17E+01 |
| A | −1.72E−02 | −2.71E−02 | 5.65E−02 | 5.39E−02 | −1.12E−01 | −5.69E−02 |
| B | 1.79E−02 | −5.10E−03 | −6.46E−02 | −3.31E−02 | 3.65E−02 | 1.48E−02 |
| C | −3.84E−02 | 4.09E−03 | 4.33E−02 | 9.41E−03 | −8.92E−03 | −2.11E−03 |
| D | 4.53E−02 | 7.88E−04 | −2.34E−02 | −1.28E−03 | 1.98E−03 | 1.97E−05 |
| E | −3.24E−02 | −1.19E−03 | 9.86E−03 | −5.97E−05 | −4.05E−04 | 6.09E−05 |
| F | 1.45E−02 | 3.10E−05 | −3.15E−03 | 4.69E−05 | 6.92E−05 | −1.52E−05 |
| G | −3.88E−03 | 3.05E−04 | 7.46E−04 | −4.17E−06 | −8.95E−06 | 2.23E−06 |
| H | 4.83E−04 | −1.63E−04 | −1.29E−04 | −8.01E−07 | 8.33E−07 | −2.26E−07 |
| J | 4.72E−05 | 4.42E−05 | 1.60E−05 | 2.48E−07 | −5.47E−08 | 1.64E−08 |
| K | −3.10E−05 | −7.33E−06 | −1.40E−06 | −2.99E−08 | 2.49E−09 | −8.37E−10 |
| M | 5.89E−06 | 7.74E−07 | 8.47E−08 | 2.05E−09 | −7.61E−11 | 2.94E−11 |
| N | −5.99E−07 | −5.10E−08 | −3.34E−09 | −8.31E−11 | 1.47E−12 | −6.73E−13 |
| O | 3.28E−08 | 1.91E−09 | 7.76E−11 | 1.85E−12 | −1.59E−14 | 9.02E−15 |
| P | −7.60E−10 | −3.12E−11 | −8.04E−13 | −1.74E−14 | 6.98E−17 | −5.36E−17 |

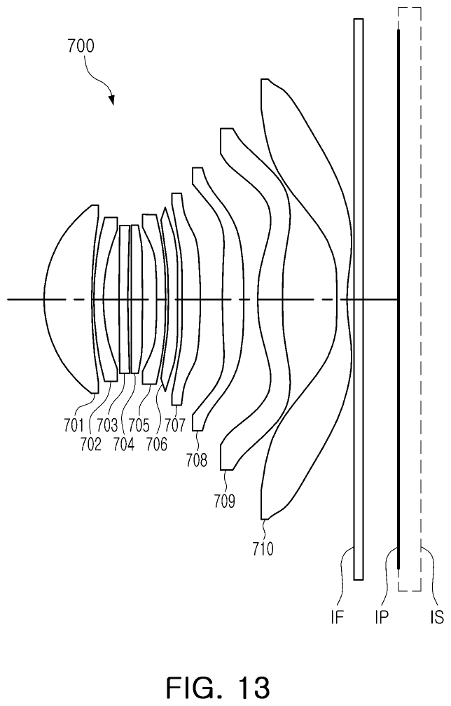

An example optical imaging system according to a seventh example embodiment will be described with reference to FIG. 13.

An example optical imaging system 700 may include a first lens 701, a second lens 702, a third lens 703, a fourth lens 704, a fifth lens 705, a sixth lens 706, a seventh lens 707, an eighth lens 708, a ninth lens 709, and a tenth lens 710.

The first lens 701 may have positive refractive power, and may have a convex object-side surface and a concave image-side surface. The second lens 702 may have negative refractive power, and may have a convex object-side surface and a concave image-side surface. The third lens 703 may have positive refractive power, and may have a convex object-side surface and a concave image-side surface. The fourth lens 704 may have negative refractive power, and may have a convex object-side surface and a concave image-side surface. The fifth lens 705 may have positive refractive power, and may have a concave object-side surface and a convex image-side surface. The sixth lens 706 may have negative refractive power, and may have a concave object-side surface and a concave image-side surface. The seventh lens 707 may have positive refractive power, and may have a convex object-side surface and a convex image-side surface. In addition, the object-side surface and image-side surface of the seventh lens 707 may have an inflection point. The eighth lens 708 may have negative refractive power, and may have a convex object-side surface and a concave image-side surface. Additionally, the object-side surface and image-side surface of the eighth lens 708 may have an inflection point. The ninth lens 709 may have positive refractive power, and may have a convex object-side surface and a concave image-side surface. Additionally, the object-side surface and image-side surface of the ninth lens 709 may have an inflection point. The tenth lens 710 may have negative refractive power, and may have a concave object-side surface and a concave image-side surface. Additionally, the object-side surface and image-side surface of the tenth lens 710 may have an inflection point.

The optical imaging system 700 may further include a filter IF and an image plane IP. The filter IF may be disposed between a tenth lens 710 and the image plane IP. In an example, the filter IF may be omitted, as necessary. The image plane IP may be formed on one surface or an inside of an image sensor IS of a camera module. However, a position of the image plane IP is not limited to the one surface or the inside of the image sensor IS.

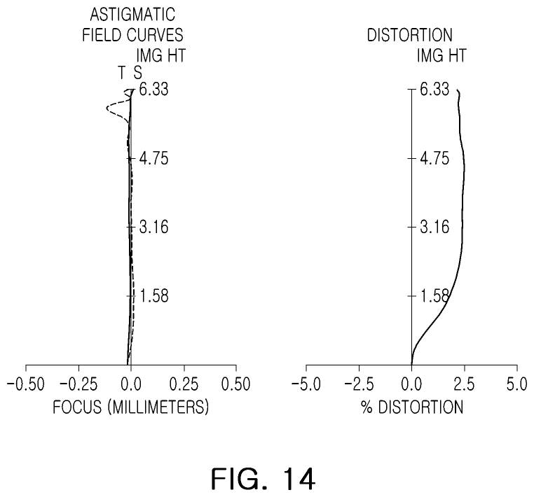

Tables 13 and 14 below illustrate lens properties and aspherical surface values of the example optical imaging system according to the present example embodiment. FIG. 14 is an aberration curve of the example optical imaging system according to the present example embodiment.

TABLE 13

| Surface | | Radius of | Thickness/ | Refractive | Abbe |
|---|---|---|---|---|---|
| No. | Component | Curvature | Distance | Index | Number |
| S1 | First lens | 2.7565 | 1.0824 | 1.544 | 56.0 |
| S2 | | 13.6550 | 0.0500 | | |
| S3 | Second lens | 6.8471 | 0.2000 | 1.671 | 19.4 |
| S4 | | 4.0223 | 0.3440 | | |
| S5 | Third lens | 14.4888 | 0.2106 | 1.544 | 56.0 |
| S6 | | 25.4021 | 0.0905 | | |
| S7 | Fourth lens | 266.1617 | 0.2352 | 1.544 | 56.0 |
| S8 | | 256.0496 | 0.3064 | | |
| S9 | Fifth lens | −26.3326 | 0.2112 | 1.671 | 19.4 |
| S10 | | −12.8156 | 0.0729 | | |
| S11 | Sixth lens | −11.0732 | 0.2039 | 1.651 | 21.5 |
| S12 | | 69.7121 | 0.0848 | | |
| S13 | Seventh lens | 52.6054 | 0.4197 | 1.544 | 56.0 |
| S14 | | −30.0290 | 0.5083 | | |
| S15 | Eighth lens | 14.7658 | 0.4621 | 1.567 | 37.4 |
| S16 | | 14.4381 | 0.3286 | | |
| S17 | Ninth lens | 3.0538 | 0.5580 | 1.544 | 56.0 |
| S18 | | 14.0936 | 1.2343 | | |
| S19 | Tenth lens | −279.8323 | 0.2325 | 1.535 | 55.7 |
| S20 | | 2.6773 | 0.1646 | | |
| S21 | Filter | Infinity | 0.2100 | 1.517 | 64.2 |
| S22 | | Infinity | 0.7723 | | |
| S23 | Image plane | Infinity | 0.0177 | | |

TABLE 14

| | Surface No. | | | | | | |
|---|---|---|---|---|---|---|---|
| | S1 | S2 | S3 | S4 | S5 | S6 | S7 |
| K | −3.29E−01 | 1.75E+01 | −1.57E+01 | −4.87E+00 | −1.95E+00 | −5.02E+01 | −9.90E+01 |
| A | 1.24E−03 | 1.48E−02 | 1.03E−02 | 3.81E−03 | −3.75E−03 | 4.17E−03 | 1.62E−05 |
| B | 1.18E−02 | −4.24E−02 | −5.14E−02 | −3.88E−02 | −1.75E−02 | −5.97E−03 | −8.87E−04 |
| C | −3.67E−02 | 8.23E−02 | 1.09E−01 | 1.52E−01 | 6.31E−02 | −1.63E−02 | −4.13E−04 |
| D | 7.52E−02 | −1.26E−01 | −1.83E−01 | −4.54E−01 | −2.56E−01 | 5.96E−02 | −3.01E−02 |
| E | −1.03E−01 | 1.51E−01 | 2.49E−01 | 9.80E−01 | 6.89E−01 | −1.06E−01 | 1.46E−01 |
| F | 9.82E−02 | −1.35E−01 | −2.57E−01 | −1.49E+00 | −1.23E+00 | 1.23E−01 | −3.28E−01 |
| G | −6.67E−02 | 8.99E−02 | 1.97E−01 | 1.63E+00 | 1.51E+00 | −9.72E−02 | 4.53E−01 |
| H | 3.27E−02 | −4.41E−02 | −1.11E−01 | −1.27E+00 | −1.30E+00 | 5.26E−02 | −4.16E−01 |
| J | −1.16E−02 | 1.59E−02 | 4.60E−02 | 7.21E−01 | 8.01E−01 | −1.96E−02 | 2.63E−01 |
| K | 2.95E−03 | −4.12E−03 | −1.38E−02 | −2.91E−01 | −3.47E−01 | 5.04E−03 | −1.15E−01 |
| M | −5.21E−04 | 7.51E−04 | 2.89E−03 | 8.17E−02 | 1.04E−01 | −8.74E−04 | 3.42E−02 |
| N | 6.10E−05 | −9.10E−05 | −4.06E−04 | −1.51E−02 | −2.03E−02 | 9.77E−05 | −6.61E−03 |
| O | −4.25E−06 | 6.59E−06 | 3.40E−05 | 1.66E−03 | 2.34E−03 | −6.35E−06 | 7.48E−04 |
| P | 1.33E−07 | −2.15E−07 | −1.28E−06 | −8.14E−05 | −1.20E−04 | 1.83E−07 | −3.76E−05 |
| | Surface No. | | | | | | |
| | S8 | S9 | S10 | S11 | S12 | S13 | S14 |
| K | 9.90E+01 | 5.17E+01 | 2.30E+01 | 6.79E+00 | −3.22E+01 | 6.87E+01 | −9.11E+01 |
| A | −8.10E−03 | −1.61E−02 | 6.97E−03 | −1.07E−04 | −1.13E−02 | −1.04E−02 | −1.22E−02 |
| B | −3.00E−02 | 3.53E−03 | −1.22E−02 | 1.79E−02 | −5.30E−03 | −1.97E−02 | −1.44E−02 |
| C | 1.58E−01 | −7.51E−02 | −3.93E−03 | −8.50E−02 | 2.85E−03 | 1.44E−02 | 6.78E−03 |
| D | −5.34E−01 | 2.54E−01 | 5.49E−02 | 2.12E−01 | −1.09E−02 | 9.12E−03 | 8.15E−03 |
| E | 1.20E+00 | −5.14E−01 | −1.26E−01 | −3.39E−01 | 3.85E−02 | −3.53E−02 | −2.04E−02 |
| F | −1.85E+00 | 6.79E−01 | 1.67E−01 | 3.74E−01 | −6.73E−02 | 4.61E−02 | 2.15E−02 |
| G | 2.02E+00 | −6.12E−01 | −1.48E−01 | −2.95E−01 | 7.04E−02 | −3.74E−02 | −1.40E−02 |
| H | −1.59E+00 | 3.82E−01 | 9.17E−02 | 1.69E−01 | −4.87E−02 | 2.04E−02 | 6.12E−03 |
| J | 8.97E−01 | −1.63E−01 | −4.04E−02 | −7.00E−02 | 2.32E−02 | −7.68E−03 | −1.83E−03 |
| K | −3.62E−01 | 4.60E−02 | 1.26E−02 | 2.08E−02 | −7.70E−03 | 1.99E−03 | 3.74E−04 |
| M | 1.02E−01 | −7.75E−03 | −2.71E−03 | −4.31E−03 | 1.74E−03 | −3.46E−04 | −5.10E−05 |
| N | −1.88E−02 | 5.53E−04 | 3.82E−04 | 5.90E−04 | −2.57E−04 | 3.89E−05 | 4.41E−06 |
| O | 2.07E−03 | 2.95E−05 | −3.18E−05 | −4.78E−05 | 2.23E−05 | −2.55E−06 | −2.16E−07 |
| P | −1.02E−04 | −5.62E−06 | 1.18E−06 | 1.74E−06 | −8.58E−07 | 7.38E−08 | 4.50E−09 |

| | Surface No. | | | | | |
|---|---|---|---|---|---|---|
| | S15 | S16 | S17 | S18 | S19 | S20 |
| K | −1.70E+00 | −9.87E+01 | −1.31E+01 | −5.31E+00 | 9.90E+01 | −1.15E+01 |
| A | −4.22E−03 | −2.65E−02 | 6.09E−02 | 5.36E−02 | −1.10E−01 | −5.44E−02 |
| B | −2.50E−02 | −4.09E−02 | −7.19E−02 | −3.54E−02 | 3.26E−02 | 1.18E−02 |
| C | 4.18E−02 | 6.75E−02 | 5.03E−02 | 1.20E−02 | −6.19E−03 | 2.29E−05 |
| D | −4.50E−02 | −5.98E−02 | −2.72E−02 | −2.48E−03 | 8.05E−04 | −8.63E−04 |
| E | 3.38E−02 | 3.65E−02 | 1.12E−02 | 2.21E−04 | −7.40E−05 | 2.94E−04 |
| F | −1.88E−02 | −1.64E−02 | −3.49E−03 | 2.24E−05 | 5.94E−06 | −5.67E−05 |
| G | 7.85E−03 | 5.47E−03 | 8.07E−04 | −8.66E−06 | −4.90E−07 | 7.37E−06 |
| H | −2.44E−03 | −1.35E−03 | −1.37E−04 | 9.89E−07 | 2.75E−08 | −6.76E−07 |
| J | 5.61E−04 | 2.43E−04 | 1.68E−05 | −4.00E−08 | 3.71E−10 | 4.43E−08 |
| K | −9.32E−05 | −3.15E−05 | −1.47E−06 | −2.06E−09 | −2.00E−10 | −2.06E−09 |
| M | 1.09E−05 | 2.84E−06 | 8.84E−08 | 3.16E−10 | 1.56E−11 | 6.64E−11 |
| N | −8.36E−07 | −1.68E−07 | −3.49E−09 | −1.48E−11 | −6.07E−13 | −1.41E−12 |
| O | 3.82E−08 | 5.88E−09 | 8.10E−11 | 3.05E−13 | 1.23E−14 | 1.76E−14 |
| P | −7.81E−10 | −9.20E−11 | −8.39E−13 | −2.09E−15 | −1.03E−16 | −9.87E−17 |

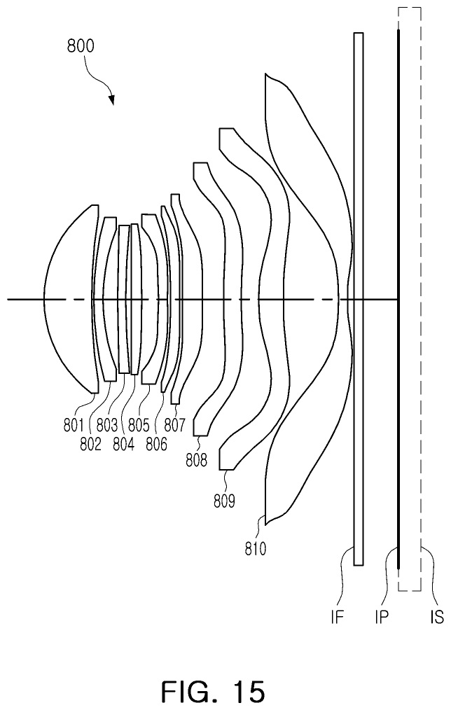

An example optical imaging system according to an eighth example embodiment will be described with reference to FIG. 15.

An example optical imaging system 800 may include a first lens 801, a second lens 802, a third lens 803, a fourth lens 804, a fifth lens 805, a sixth lens 806, a seventh lens 807, an eighth lens 808, a ninth lens 809, and a tenth lens 810.

The first lens 801 may have positive refractive power, and may have a convex object-side surface and a concave image-side surface. The second lens 802 may have negative refractive power, and may have a convex object-side surface and a concave image-side surface. The third lens 803 may have positive refractive power, and may have a convex object-side surface and a concave image-side surface. The fourth lens 804 may have positive refractive power, and may have a convex object-side surface and a convex image-side surface. The fifth lens 805 may have positive refractive power, and may have a concave object-side surface and a convex image-side surface. The sixth lens 806 may have negative refractive power, and may have a concave object-side surface and a concave image-side surface. The seventh lens 807 may have positive refractive power, and may have a convex object-side surface and a convex image-side surface. In addition, the object-side surface and image-side surface of the seventh lens 807 may have an inflection point. The eighth lens 808 may have negative refractive power, and may have a convex object-side surface and a concave image-side surface. Additionally, the object-side surface and image-side surface of the eighth lens 808 may have an inflection point. The ninth lens 809 may have positive refractive power, and may have a convex object-side surface and a concave image-side surface. Additionally, the object-side surface and image-side surface of the ninth lens 809 may have an inflection point. The tenth lens 810 may have negative refractive power, and may have a concave object-side surface and a concave image-side surface. Additionally, the object-side surface and image-side surface of the tenth lens 810 may have an inflection point.

The optical imaging system 800 may further include a filter IF and an image plane IP. The filter IF may be disposed between a tenth lens 810 and the image plane IP. In an example, the filter IF may be omitted, as necessary. The image plane IP may be formed on one surface or an inside of an image sensor IS of a camera module. However, a position of the image plane IP is not limited to the one surface or the inside of the image sensor IS.

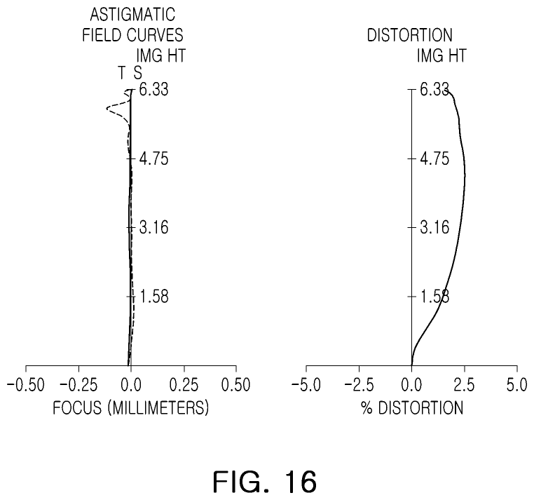

Tables 15 and 16 below illustrate lens properties and aspherical surface values of the example optical imaging system according to the present example embodiment. FIG. 16 is an aberration curve of the example optical imaging system according to the present example embodiment.

TABLE 15

| Surface | | Radius of | Thickness/ | Refractive | Abbe |
|---|---|---|---|---|---|
| No. | Component | Curvature | Distance | Index | Number |
| S1 | First lens | 2.7877 | 1.0652 | 1.544 | 56.0 |
| S2 | | 13.3752 | 0.0500 | | |
| S3 | Second lens | 5.7905 | 0.2000 | 1.671 | 19.4 |
| S4 | | 3.6781 | 0.3157 | | |
| S5 | Third lens | 11.7552 | 0.2106 | 1.567 | 37.4 |
| S6 | | 13.4295 | 0.1063 | | |
| S7 | Fourth lens | 39.1993 | 0.2566 | 1.544 | 56.0 |
| S8 | | −203.9568 | 0.3741 | | |
| S9 | Fifth lens | −15.0970 | 0.2111 | 1.671 | 19.4 |
| S10 | | −12.5232 | 0.0640 | | |
| S11 | Sixth lens | −11.2835 | 0.2033 | 1.635 | 23.9 |
| S12 | | 59.4243 | 0.0673 | | |
| S13 | Seventh lens | 78.1053 | 0.4552 | 1.544 | 56.0 |
| S14 | | −14.1710 | 0.4721 | | |
| S15 | Eighth lens | 8.7030 | 0.4034 | 1.614 | 25.9 |
| S16 | | 7.7030 | 0.3861 | | |
| S17 | Ninth lens | 3.0214 | 0.5675 | 1.544 | 56.0 |
| S18 | | 12.6871 | 1.2390 | | |
| S19 | Tenth lens | −921.8796 | 0.2000 | 1.535 | 55.7 |
| S20 | | 2.6509 | 0.1524 | | |
| S21 | Filter | Infinity | 0.2100 | 1.517 | 64.2 |
| S22 | | Infinity | 0.7768 | | |
| S23 | Image plane | Infinity | 0.0132 | | |

TABLE 16

| | Surface No. | | | | | | |
|---|---|---|---|---|---|---|---|
| | S1 | S2 | S3 | S4 | S5 | S6 | S7 |
| K | −3.44E−01 | 9.36E+00 | −2.27E+01 | −6.22E+00 | 1.74E+00 | −9.87E+01 | −9.90E+01 |
| A | 1.40E−03 | 8.97E−03 | 1.08E−02 | 7.00E−03 | −2.81E−03 | 1.03E−03 | −7.56E−03 |
| B | 9.38E−03 | −4.08E−02 | −5.23E−02 | −3.18E−02 | −1.29E−02 | −9.11E−03 | −1.09E−03 |
| C | −2.92E−02 | 8.33E−02 | 9.15E−02 | 7.25E−02 | 2.50E−02 | −1.54E−03 | 4.20E−03 |
| D | 6.12E−02 | −1.20E−01 | −1.11E−01 | −1.50E−01 | −9.39E−02 | 2.13E−02 | −3.77E−02 |
| E | −8.58E−02 | 1.33E−01 | 1.07E−01 | 2.66E−01 | 2.61E−01 | −3.55E−02 | 1.55E−01 |
| F | 8.36E−02 | −1.14E−01 | −8.27E−02 | −3.64E−01 | −4.72E−01 | 3.58E−02 | −3.33E−01 |
| G | −5.79E−02 | 7.39E−02 | 5.02E−02 | 3.70E−01 | 5.79E−01 | −2.42E−02 | 4.49E−01 |
| H | 2.89E−02 | −3.61E−02 | −2.36E−02 | −2.76E−01 | −4.93E−01 | 1.09E−02 | −4.08E−01 |
| J | −1.04E−02 | 1.30E−02 | 8.38E−03 | 1.49E−01 | 2.96E−01 | −3.26E−03 | 2.57E−01 |
| K | 2.69E−03 | −3.43E−03 | −2.21E−03 | −5.81E−02 | −1.25E−01 | 6.31E−04 | −1.13E−01 |
| M | −4.83E−04 | 6.34E−04 | 4.19E−04 | 1.58E−02 | 3.60E−02 | −7.57E−05 | 3.40E−02 |
| N | 5.74E−05 | −7.83E−05 | −5.40E−05 | −2.82E−03 | −6.79E−03 | 5.04E−06 | −6.68E−03 |
| O | −4.05E−06 | 5.78E−06 | 4.25E−06 | 2.98E−04 | 7.54E−04 | −1.30E−07 | 7.72E−04 |
| P | 1.29E−07 | −1.92E−07 | −1.54E−07 | −1.41E−05 | −3.73E−05 | −1.19E−09 | −3.99E−05 |
| | Surface No. | | | | | | |
| | S8 | S9 | S10 | S11 | S12 | S13 | S14 |
| K | −9.90E+01 | 5.86E+01 | 3.72E+01 | 1.40E+01 | −9.90E+01 | −7.20E+01 | −3.12E+01 |
| A | −6.78E−03 | −9.90E−03 | 1.10E−02 | 5.91E−04 | −2.85E−03 | 6.57E−03 | −1.25E−02 |
| B | −1.47E−02 | −1.59E−02 | −1.56E−02 | 1.40E−02 | −2.22E−02 | −2.73E−02 | −8.96E−03 |
| C | 6.35E−02 | −3.69E−03 | −1.41E−02 | −6.96E−02 | 1.05E−02 | −1.97E−02 | −6.86E−03 |
| D | −1.79E−01 | 5.60E−02 | 9.22E−02 | 1.70E−01 | 2.64E−03 | 9.81E−02 | 2.36E−02 |
| E | 3.47E−01 | −1.42E−01 | −2.09E−01 | −2.63E−01 | 6.91E−03 | −1.52E−01 | −3.06E−02 |
| F | −4.68E−01 | 1.96E−01 | 2.88E−01 | 2.80E−01 | −3.09E−02 | 1.45E−01 | 2.54E−02 |
| G | 4.50E−01 | −1.65E−01 | −2.67E−01 | −2.13E−01 | 4.13E−02 | −9.52E−02 | −1.46E−02 |
| H | −3.12E−01 | 8.24E−02 | 1.74E−01 | 1.17E−01 | −3.14E−02 | 4.42E−02 | 5.85E−03 |
| J | 1.56E−01 | −1.80E−02 | −8.04E−02 | −4.68E−02 | 1.56E−02 | −1.46E−02 | −1.65E−03 |
| K | −5.56E−02 | −4.54E−03 | 2.62E−02 | 1.33E−02 | −5.20E−03 | 3.39E−03 | 3.24E−04 |
| M | 1.38E−02 | 4.58E−03 | −5.91E−03 | −2.65E−03 | 1.17E−03 | −5.40E−04 | −4.31E−05 |
| N | −2.24E−03 | −1.46E−03 | 8.75E−04 | 3.46E−04 | −1.69E−04 | 5.60E−05 | 3.68E−06 |
| O | 2.15E−04 | 2.26E−04 | −7.67E−05 | −2.68E−05 | 1.43E−05 | −3.41E−06 | −1.81E−07 |
| P | −9.19E−06 | −1.44E−05 | 3.01E−06 | 9.29E−07 | −5.33E−07 | 9.26E−08 | 3.86E−09 |

| | Surface No. | | | | | |
|---|---|---|---|---|---|---|
| | S15 | S16 | S17 | S18 | S19 | S20 |
| K | −1.95E+01 | −5.35E+01 | −1.30E+01 | −1.38E+01 | −9.90E+01 | −1.28E+01 |
| A | −1.71E−02 | −3.94E−02 | 3.21E−02 | 3.00E−02 | −1.40E−01 | −7.32E−02 |
| B | −3.70E−03 | 2.58E−03 | −4.08E−02 | −2.41E−02 | 6.75E−02 | 3.28E−02 |
| C | 1.95E−02 | 1.94E−02 | 2.73E−02 | 1.02E−02 | −2.65E−02 | −1.12E−02 |
| D | −2.88E−02 | −2.41E−02 | −1.38E−02 | −3.23E−03 | 8.44E−03 | 2.95E−03 |
| E | 2.45E−02 | 1.64E−02 | 5.20E−03 | 8.20E−04 | −2.03E−03 | −5.82E−04 |
| F | −1.42E−02 | −7.51E−03 | −1.47E−03 | −1.74E−04 | 3.57E−04 | 8.54E−05 |
| G | 5.86E−03 | 2.44E−03 | 3.09E−04 | 3.05E−05 | −4.56E−05 | −9.26E−06 |
| H | −1.76E−03 | −5.73E−04 | −4.73E−05 | −4.13E−06 | 4.22E−06 | 7.42E−07 |
| J | 3.84E−04 | 9.68E−05 | 5.25E−06 | 4.11E−07 | −2.82E−07 | −4.35E−08 |
| K | −6.02E−05 | −1.16E−05 | −4.13E−07 | −2.86E−08 | 1.35E−08 | 1.84E−09 |
| M | 6.61E−06 | 9.61E−07 | 2.25E−08 | 1.33E−09 | −4.51E−10 | −5.48E−11 |
| N | −4.82E−07 | −5.21E−08 | −8.02E−10 | −3.84E−11 | 9.97E−12 | 1.08E−12 |
| O | 2.09E−08 | 1.66E−09 | 1.69E−11 | 5.97E−13 | −1.31E−13 | −1.28E−14 |
| P | −4.08E−10 | −2.37E−11 | −1.59E−13 | −3.46E−15 | 7.81E−16 | 6.83E−17 |

Tables 17 to 19 below illustrate optical property values and conditional expression values of the example optical imaging systems according to the first to eighth example embodiments.

TABLE 17

| | First Example | Second Example | Third Example | Fourth Example |
|---|---|---|---|---|
| Note | Embodiment | Embodiment | Embodiment | Embodiment |
| f1 | 6.1075 | 6.1019 | 6.1225 | 6.1176 |
| f2 | −14.3650 | −15.1325 | −15.0421 | −15.0686 |
| f3 | 50.0969 | 215.2759 | 69.0721 | 61.2670 |
| f4 | −460.3936 | 70.6947 | 624.0428 | −65806.9610 |
| f5 | 33.0280 | 51.7849 | 38.3092 | 42.0637 |
| f6 | −14.1384 | −15.8856 | −14.6614 | −14.9502 |
| f7 | 33.2329 | 34.8636 | 34.2600 | 36.0124 |
| f8 | 3926.0889 | −84.9877 | −2865.1704 | 99.9992 |
| f9 | 7.1395 | 6.6488 | 7.0013 | 7.3624 |
| f10 | −4.9376 | −4.9340 | −4.9194 | −4.8933 |
| TTL | 8.0000 | 8.0000 | 8.0000 | 8.0000 |
| BFL | 1.1652 | 1.1560 | 1.1632 | 1.1625 |
| f | 6.5563 | 6.5925 | 6.5470 | 6.5490 |
| f number | 1.69 | 1.69 | 1.69 | 1.70 |
| IMG HT | 6.1290 | 6.1290 | 6.1290 | 6.1290 |
| FOV | 84.8000 | 84.3925 | 84.7913 | 84.7875 |
| | Fifth Example | Sixth Example | Seventh Example | Eighth Example |
| Note | Embodiment | Embodiment | Embodiment | Embodiment |
| f1 | 6.1137 | 6.1270 | 6.1135 | 6.2312 |
| f2 | −14.8896 | −14.9820 | −14.8264 | −15.4864 |
| f3 | 98.6819 | 61.9528 | 61.3731 | 158.2268 |
| f4 | 150.6248 | −20491.2680 | −12450.6144 | 60.2659 |
| f5 | 38.4832 | 38.1129 | 36.6495 | 105.0322 |
| f6 | −14.5358 | −14.3925 | −14.5577 | −14.8092 |
| f7 | 35.2787 | 78.3662 | 35.0888 | 22.0154 |
| f8 | −1695.4961 | 18.1693 | −2337.6810 | −128.1072 |
| f9 | 6.9707 | 9.4775 | 7.0177 | 7.1186 |
| f10 | −4.9328 | −4.8755 | −4.9407 | −4.9256 |
| TTL | 8.0000 | 7.9945 | 8.0000 | 8.0000 |
| BFL | 1.1651 | 1.1610 | 1.1646 | 1.1524 |
| f | 6.5561 | 6.5387 | 6.5590 | 6.5988 |
| f number | 1.70 | 1.70 | 1.70 | 1.70 |
| IMG HT | 6.1290 | 6.1290 | 6.1290 | 6.1290 |
| FOV | 84.6860 | 85.2543 | 84.7074 | 84.5406 |

TABLE 18

| Conditional | First Example | Second Example | Third Example | Fourth Example |
|---|---|---|---|---|
| Expression | Embodiment | Embodiment | Embodiment | Embodiment |
| f1/f | 0.9315 | 0.9256 | 0.9352 | 0.9341 |
| V1-V2 | 36.5900 | 36.5900 | 36.5900 | 36.5900 |
| V3-V2 | 36.5900 | 18.0000 | 36.5900 | 36.5900 |
| V1-(V6 + V7)/2 | 17.2450 | 16.2450 | 17.2450 | 17.2450 |
| f2/f | −2.1910 | −2.2954 | −2.2976 | −2.3009 |
| \|f3/f\| | 7.6410 | 32.6547 | 10.5502 | 9.3552 |
| \|f5/f\| | 5.0376 | 7.8551 | 5.8514 | 6.4229 |
| f6/1 | −2.1565 | −2.4096 | −2.2394 | −2.2828 |
| f7/1 | 5.0689 | 5.2884 | 5.2329 | 5.4989 |
| f9/1 | 1.0890 | 1.0085 | 1.0694 | 1.1242 |
| f10/f | −0.7531 | −0.7484 | −0.7514 | −0.7472 |
| TTL/f | 1.2202 | 1.2135 | 1.2219 | 1.2216 |
| f1/f2 | −0.4252 | −0.4032 | −0.4070 | −0.4060 |
| f1/f3 | 0.1219 | 0.0283 | 0.0886 | 0.0999 |
| BFL/f | 0.1777 | 0.1754 | 0.1777 | 0.1775 |
| D12/f | 0.0111 | 0.0076 | 0.0076 | 0.0076 |
| TTL/(2*ImgHT) | 0.6526 | 0.6526 | 0.6526 | 0.6526 |
| FOV*ImgHT/f | 79.2732 | 78.4591 | 79.3777 | 79.3499 |
| SmT23 | 0.4133 | 0.4090 | 0.4104 | 0.4107 |
| SmT3456 | 0.8989 | 0.8966 | 0.9017 | 0.8415 |
| SmT23/TTL | 0.0517 | 0.0511 | 0.0513 | 0.0513 |
| f2/f6 | 1.0160 | 0.9526 | 1.0260 | 1.0079 |
| Conditional | Fifth Example | Sixth Example | Seventh Example | Eighth Example |
| Expression | Embodiment | Embodiment | Embodiment | Embodiment |
| f1/f | 0.93253 | 0.93704 | 0.93208 | 0.94430 |
| V1-V2 | 36.59000 | 36.59000 | 36.59000 | 36.59000 |
| V3-V2 | 36.59000 | 36.59000 | 36.59000 | 18.00000 |
| V1-(V6 + V7)/2 | 17.24500 | 17.24500 | 17.24500 | 16.04500 |
| f2/f | −2.27111 | −2.29128 | −2.26046 | −2.34685 |
| \|f3/f\| | 15.05192 | 9.47479 | 9.35709 | 23.97812 |
| \|f5/f\| | 5.86983 | 5.82881 | 5.58767 | 15.91686 |
| f6/f | −2.21714 | −2.20113 | −2.21950 | −2.24422 |
| f7/f | 5.38106 | 11.98498 | 5.34971 | 3.33628 |
| f9/f | 1.06324 | 1.44945 | 1.06993 | 1.07878 |
| f10/f | −0.75240 | −0.74564 | −0.75327 | −0.74643 |
| TTL/f | 1.22024 | 1.22265 | 1.21970 | 1.21234 |
| f1/f2 | −0.41060 | −0.40896 | −0.41234 | −0.40237 |
| f1/f3 | 0.06195 | 0.09890 | 0.09961 | 0.03938 |
| BFL/f | 0.17771 | 0.17756 | 0.17756 | 0.17464 |
| D12/f | 0.00763 | 0.00787 | 0.00762 | 0.00758 |
| TTL/(2*ImgHT) | 0.65263 | 0.65219 | 0.65264 | 0.65264 |
| FOV*ImgHT/f | 79.16905 | 79.91244 | 79.15408 | 78.52177 |
| SmT23 | 0.40798 | 0.41114 | 0.41065 | 0.41064 |
| SmT3456 | 0.83771 | 0.83664 | 0.86098 | 0.88163 |
| SmT23/TTL | 0.05100 | 0.05143 | 0.05133 | 0.05133 |
| f2/f6 | 1.02434 | 1.04096 | 1.01846 | 1.04573 |

TABLE 19

| Conditional | First Example | Second Example | Third Example | Fourth Example |
|---|---|---|---|---|
| Expression | Embodiment | Embodiment | Embodiment | Embodiment |
| f1/f9 | 0.85545 | 0.91775 | 0.87447 | 0.83093 |
| f5/f7 | 0.99383 | 1.48535 | 1.11819 | 1.16804 |
| f9/f10 | −1.44596 | −1.34754 | −1.42321 | −1.50459 |
| (f1 + f7)/(f2 + f6) | −1.38020 | −1.32070 | −1.35952 | −1.40345 |
| R17/R20 | 1.17829 | 1.08954 | 1.14607 | 1.20261 |
| \|R20/f10\| | 0.53891 | 0.54386 | 0.54277 | 0.54467 |
| f3/R5 | 3.95240 | 19.21842 | 4.78215 | 4.04350 |
| f3/R6 | 2.14102 | 17.64334 | 2.96518 | 2.22218 |
| f3/R5-f3/R6 | 1.81138 | 1.57508 | 1.81697 | 1.82132 |
| f4/R7-f4/R8 | 1.83695 | 1.82831 | 1.82973 | 1.84547 |
| f6/R11 | 1.33856 | 1.29811 | 1.28629 | 1.28166 |
| f6/R12 | −0.16671 | −0.25699 | −0.23707 | −0.24168 |
| f6/R11-f6/R12 | 1.50527 | 1.55511 | 1.52336 | 1.52334 |
| Conditional | Fifth Example | Sixth Example | Seventh Example | Eighth Example |
| Expression | Embodiment | Embodiment | Embodiment | Embodiment |
| f1/f9 | 0.87706 | 0.64648 | 0.87116 | 0.87534 |
| f5/f7 | 1.09083 | 0.48634 | 1.04448 | 4.77084 |
| f9/f10 | −1.41312 | −1.94389 | −1.42039 | −1.44524 |
| (f1 + f7)/(f2 + f6) | −1.40669 | −2.87641 | −1.40220 | −0.93237 |
| R17/R20 | 1.13556 | 1.44438 | 1.14061 | 1.13976 |
| \|R20/f10\| | 0.54235 | 0.54222 | 0.54189 | 0.53819 |
| f3/R5 | 6.76046 | 4.21820 | 4.23589 | 13.46013 |
| f3/R6 | 4.95316 | 2.39815 | 2.41607 | 11.78207 |
| f3/R5-f3/R6 | 1.80730 | 1.82005 | 1.81982 | 1.67806 |
| f4/R7-f4/R8 | 1.83178 | 1.84596 | 1.84740 | 1.83291 |
| f6/R11 | 1.28862 | 1.27620 | 1.31468 | 1.31246 |
| f6/R12 | −0.23473 | −0.24708 | −0.20883 | −0.24921 |
| f6/R11-f6/R12 | 1.52335 | 1.52328 | 1.52351 | 1.56167 |

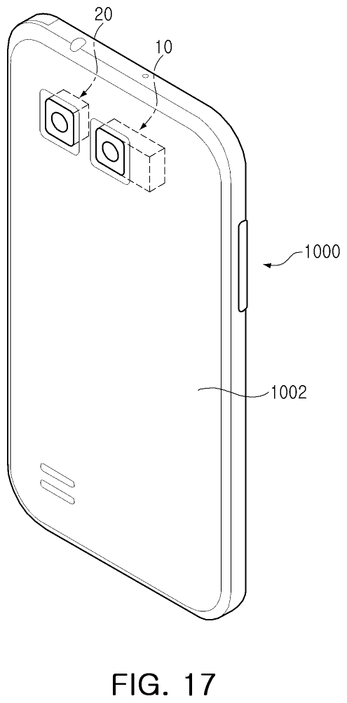

An example electronic device according to the one or more examples will be described with reference to FIG. 17.

The example electronic device according to the one or more examples may include an optical imaging system according to an example. For example, the electronic device may include one or more of the optical imaging systems according to the first to eighth example embodiments. As a specific example, the electronic device may include the optical imaging system 100 according to the first example embodiment.

An electronic device according to an example embodiment may be, as non-limited examples, a portable terminal 1000, as illustrated in FIG. 17. However, the form of the electronic device is not limited to the portable terminal 1000. For example, an electronic device according to another example embodiment may be in the form of a laptop computer.

The portable terminal 1000 may include one or a plurality of camera modules 10 and 20. For example, two camera modules 10 and 20 may be installed in a body 1002 of the portable terminal 1000 at a predetermined interval. A first camera module 10 and a second camera module 20 may be configured to capture an image of an object in the same direction. For example, the first camera module 10 and the second camera module 20 may be mounted on one surface of the portable terminal 1000 to be parallel to each other.

One or more of the first camera module 10 and the second camera module 20 may include the optical imaging systems according to the first to eighth example embodiments. For example, the second camera module 20 may include the optical imaging system 100 according to the first example embodiment.

While this disclosure includes specific examples, it will be apparent to one of ordinary skill in the art, after an understanding of the disclosure of this application, that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An optical imaging system, comprising:
a first lens, a second lens, a third lens, a fourth lens, a fifth lens, a sixth lens, a seventh lens, an eighth lens, a ninth lens, and a tenth lens,
wherein the third lens has positive refractive power,
wherein the first lens to the tenth lens are sequentially disposed from an object side to an imaging side, and
wherein TTL/(2*ImgHT)<0.66 and 0.5 mm<SmT3456<1.5 mm,
where TTL is a distance from an object-side surface of the first lens to an image plane, ImgHT is a height of the image plane, and SmT3456 is a sum of thicknesses of the third lens to the sixth lens.

2. The optical imaging system of claim 1, wherein:
$$0 < f 1 / f < 1.4 ,$$
where f is a focal length of the optical imaging system and f1 is a focal length of the first lens.

3. The optical imaging system of claim 1, wherein:
$$- 10 < f 2 / f < - 1.0 ,$$
where f is a focal length of the optical imaging system and f2 is a focal length of the second lens.

4. The optical imaging system of claim 1, wherein:
$$1. < \vert f 3 / f \vert < 35 ,$$
where f is a focal length of the optical imaging system and f3 is a focal length of the third lens.

5. The optical imaging system of claim 1, wherein:
$$3. < \vert f 5 / f \vert < 20 ,$$
where f is a focal length of the optical imaging system and f5 is a focal length of the fifth lens.

6. The optical imaging system of claim 1, wherein:
$$- 10 < f 6 / f < - 1.0 ,$$
where f is a focal length of the optical imaging system and f6 is a focal length of the sixth lens.

7. The optical imaging system of claim 1, wherein:
$$2.0 < f 7 / f < 15 ,$$
where f is a focal length of the optical imaging system and f7 is a focal length of the seventh lens.

8. The optical imaging system of claim 1, wherein:
$$0 < f 9 / f < 2.0 ,$$
where f is a focal length of the optical imaging system and f9 is a focal length of the ninth lens.

9. The optical imaging system of claim 1, wherein:
$$- 1.0 < f 10 / f < 0 ,$$
where f is a focal length of the optical imaging system and f10 is a focal length of the tenth lens.

10. An electronic device, comprising the optical imaging system of claim 1.

11. An optical imaging system, comprising:
a first lens, a second lens, a third lens, a fourth lens, a fifth lens, a sixth lens, a seventh lens, an eighth lens, a ninth lens, and a tenth lens,
wherein the third lens has positive refractive power,
wherein the first lens to the tenth lens are sequentially disposed from an object side to an imaging side, and
wherein 0.9<f2/f6<1.20,
where f2 is a focal length of the second lens and f6 is a focal length of the sixth lens.

12. The optical imaging system of claim 11, wherein:
$$0.6 < f 1 / f 9 < 1. ,$$
where f1 is a focal length of the first lens and f9 is a focal length of the ninth lens.

13. The optical imaging system of claim 11, wherein:
$$0.9 < f 5 / f 7 < 1.50 ,$$
where f5 is a focal length of the fifth lens and f7 is a focal length of the seventh lens.

14. The optical imaging system of claim 11, wherein
$$- 2.0 < f 9 / f 10 < - 1.2 ,$$
where f9 is a focal length of the ninth lens and f10 is a focal length of the tenth lens.

15. The optical imaging system of claim 11, wherein:
$$- 3.0 < ( f 1 + f 7 ) / ( f 2 + f 6 ) < - 0.8 ,$$
where f1 is a focal length of the first lens and f7 is a focal length of the seventh lens.

16. The optical imaging system of claim 11, wherein:
$$1. 5 < f 3 / R 5 - f 3 / R 6 < 2.0 ,$$
where f3 is a focal length of the third lens, R5 is a radius of curvature of an object-side surface of the third lens, and R6 is a radius of curvature of an image-side surface of the third lens.

17. The optical imaging system of claim 11, wherein:
$$0.5 < \vert R 20 / f 10 \vert < 0.6 ,$$
where f10 is a focal length of the tenth lens and R20 is a radius of curvature of an image-side surface of the tenth lens.

18. An electronic device, comprising the optical imaging system of claim 11.

19. An optical imaging system, comprising:
a first lens, a second lens, a third lens, a fourth lens, a fifth lens, a sixth lens, a seventh lens, an eighth lens, a ninth lens, and a tenth lens,
wherein the fourth lens has negative refractive power,
wherein the eighth lens has positive refractive power,
wherein the first lens to the tenth lens are sequentially disposed from an object side to an imaging side, and
wherein TTL/(2*ImgHT)<0.66,
where TTL is a distance from an object-side surface of the first lens to an image plane, and ImgHT is a height of the image plane.

20. An electronic device, comprising the optical imaging system of claim 19.
